(19) United States
(12) Patent Application Publication
(10) Pub. No.: US 2015/0212664 A1
(43) Pub. Date: Jul. 30, 2015

(54) SYSTEM AND METHODS FOR CONTENT-SEARCH CAROUSEL FOR MOBILE-COMPUTING DEVICES

(71) Applicant: IQnect Technology Limited, Road Town (VG)

(72) Inventor: Carl J. Freer, SG (SG)

(73) Assignee: IQnect Technology Limited, Road Town (VG)

(21) Appl. No.: 14/420,533

(22) PCT Filed: Sep. 25, 2012
(86) PCT No.: PCT/US2012/056974

§ 371 Date: Feb. 9, 2015

Related U.S. Application Data
(60) Provisional application No. 61/545,729, filed on Oct. 11, 2011.

(51) Int. Cl. G06F 3/0482; G06Q 30/02; G06F 17/30; G06F 3/0485; G06F 3/0481; G06F 3/16

(52) U.S. Cl. CPC G06F 3/0482; G06F 3/04817; G06F 3/167; G06F 17/30864; G06F 3/0485; G06Q 30/0256

(57) ABSTRACT

The inventive concepts described herein are generally directed to a mobile and fixedline software application that provides a user with an enhanced graphical toolbar with an edge-on view of a carousel interface populated with a plurality of selectable icons representing information-search channels, and with an integrated, multi-input search bar, which is integrated with the software application and can be communicatively coupled with supporting back-end architecture. This enhanced toolbar is referred to as the Content Search Carousel (CSC), and is especially adapted for use with mobile-computing devices, as it maximizes functionality while minimizing the amount of device-display real estate that is taken up at the expense of other mobile-computing application functionality.

### CROSS-REFERENCE TO RELATED APPLICATIONS

The present patent application claims the priority benefit of U.S. Patent Application No. 61/545,729, filed on Oct. 11, 2011, for “System and Methods for Content-Search Carousel for Mobile-Computing Devices”, and the present patent application hereby incorporates by reference U.S. Patent Application No. 61/545,729 in its entirety for all purposes.

### BACKGROUND

The field of endeavor for the present inventive disclosure pertains to information-retrieval search software tools that can be incorporated within and/or used in conjunction with, software applications used by computing devices, especially mobile computing devices.

### BRIEF DESCRIPTION OF THE DRAWINGS

FIG. 1A depicts one embodiment of the interactive process required for a user to make a selection in the Carousel, and also includes the interaction between the Carousel portion of the CSC and the containing application.

FIG. 1B depicts one embodiment of a user's selection of an icon within the Carousel with the user's finger interposed.

FIG. 2A depicts one embodiment of the interactive process between a user and the CSC to add or remove selections in the Carousel.

FIG. 2B depicts one embodiment of a user screen to facilitate the rearranging of Carousel Items.

FIG. 3A depicts one embodiment of the process for user-text entering in the Searchbar for the purpose of causing the enclosing application to search the preferred search platform as selected in the Carousel using the user-entered search term.

FIG. 3B depicts one embodiment of a user's CSC text-entry interface.

FIG. 4A depicts one embodiment of the interactive process required for a user to enter a search term using spoken language for the purpose of causing the enclosing application to search the preferred search platform as selected in the Carousel using the user-spoken search term.

FIG. 4B depicts one embodiment of a user's audio input in the CSC.

FIG. 5A depicts one embodiment of the interactive process required for a user to enter a search term using an image for the purpose of causing the enclosing application to search the preferred search platform as selected in the Carousel using the derived search term.

FIG. 5B depicts one embodiment of a user's photo input in the CSC.

FIG. 6A depicts one embodiment of the interactive process required for a user to enter a search term using a barcode image for the purpose of causing the enclosing application to search the preferred search platform, as selected in the Carousel, using the barcode-derived search term.

FIG. 6B depicts one embodiment of a user's barcode input in the CSC.

FIG. 7A provides a diagram of one embodiment of an overview of the CSC data flow, and is intended to represent a top-level view of the relationships between a user, the CSC software, the back-end support architecture, and the enclosing application.

FIG. 7B depicts one embodiment of the data flow associated with messaging between a user and an enclosing application via the Carousel.

FIG. 7C depicts one embodiment of the data flow associated with messaging between a user and an enclosing application via the Searchbar.

FIG. 8A depicts one embodiment of the class definitions and dependencies in support of the implementing software for the CSC Carousel.

FIG. 8B depicts one embodiment of the class definitions and dependencies in support of the implementing software for the CSC Searchbar.

FIG. 9 depicts one embodiment of the basic components of the back-end CSC-supporting system architecture. The back-end architecture supports the CSC through the Searchbar object.

FIG. 10A depicts one embodiment of a user screen containing a variation of the Carousel interface that includes a “child” Carousel that is associated with a user-selected icon from the “parent” Carousel, wherein the “child” Carousel is located proximal to the “parent” Carousel and is oriented substantially parallel to the “Parent” Carousel.

FIG. 10B depicts one embodiment of a user screen containing a variation of the Carousel interface that includes a “child” Carousel that is associated with a user-selected icon from the “parent” Carousel, wherein the “child” Carousel is located proximal to the “parent” Carousel and is oriented substantially orthogonally to the “Parent” Carousel.

### DETAILED DESCRIPTION

### I. Content-Search Carousel (CSC) Overview

The inventive concepts described herein are generally directed to a mobile and fixed-line application that provides a user with an enhanced experience to search for and retrieve relevant content. Hereinafter, this application is referred to as the Content Search Carousel (CSC).

The CSC application is presented to a user via a unique toolbar/searchbar of sorts, wherein a user can conceptually scroll in either direction of the toolbar to select any of a plurality of user-defined and/or application-defined icons that the user can select to invoke certain functionality. The conceptual “Carousel” aspect arises because a user can scroll in either direction and eventually traverse across all of the icons contained in a given embodiment of the CSC. The CSC allows for a user to select the search platform preference for the display of search results. This selection mechanism is known, in some embodiments, as the “Carousel”.

The CSC is stand-alone software that can be used in an application to provide a basis for entering search terms using text, audio input, image input, or barcode input. Audio input and image input are translated to text, so the application can perform a simple text-based search. In some embodiments, the portion of the CSC that provides for these three types of search term inputs is referred to as the Searchbar.

Generally speaking, the CSC provides access to a comprehensive search method, which in turn collates direct (or indirect) informative data, relative to the search enquiry. In some embodiments, the CSC can be delivered in the form of an Application Programming Interface (API) that is agnostic across several popular operating systems, both fixed and mobile.

### II. Terminology

The terms and phrases as indicated in quotes (“ ”) in this section are intended to have the meaning ascribed to them in this Terminology section applied to them throughout this patent application, unless clearly indicated otherwise in context. Further, as applicable, the stated definitions are to apply, regardless of the word or phrase's case, to the singular and plural variations of the defined word or phrase.

The term “or”, as used in this patent application, is not meant to be exclusive; rather, the term is inclusive, meaning “either or both”.

References in this patent application to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of the phrase “in one embodiment” and/or “in one variation”, and similar phrases, in various places in this patent application are not necessarily all meant to refer to the same embodiment.

The term “couple” or “coupled”, as used in this s patent application, refers to either an indirect or a direct connection between the identified elements, components, or objects. Often the manner of the coupling will be related specifically to the manner in which the two coupled elements interact.

The term “removable”, “removably coupled”, “readily removable”, “readily detachable”, and similar terms, as used in this patent application (including the drawings), refer to structures that can be uncoupled from an adjoining structure with relative ease (i.e., non-destructively and without a complicated or time-consuming process) and that can also be readily reattached or coupled to the previously adjoining structure. In addition, in the case of computer software, such references to “removable coupling” can include the enabling and disabling of communicative coupling between program modules and/or physical computing components, and can also refer to stand-alone software modules and/or libraries that other parts of an application call or destroy references to.

Directional and/or relational terms such as, but not limited to, left, right, nadir, apex, top, bottom, vertical, horizontal, back, front, and lateral are relative to each other, are dependent on the specific orientation of an applicable element or article, are used accordingly to aid in the description of the various embodiments, and are not necessarily intended to be construed as limiting.

As applicable, the terms “about” or “generally”, as used herein unless otherwise indicated, means a margin of +−20%. Also, as applicable, the term “substantially” as used herein unless otherwise indicated means a margin of +−10%. It is to be appreciated that not all uses of the above terms are quantifiable such that the referenced ranges can be applied.

The terms “computer-readable medium”, “computer-readable media”, “machine-accessible storage medium”, “machine-readable storage media”, and other similar terms, as used in this patent application including the appended claims, while often described as a single medium, includes a single medium or multiple media (e.g., a centralized or distributed database, and/or associated caches and servers) that store the one or more sets of instructions. In addition, references to “computer-readable medium” (and/or similar terms) include any medium that is capable of storing, encoding, or carrying a set of instruction for execution by the machine and that cause the machine to perform any one or more of the methodologies of the present inventive concepts. Accordingly, “computer-readable medium” (and similar terms) shall be taken to include, but not be limited to, solid-state memories, optical media, and magnetic media.

### III. General CSC Functionality Description

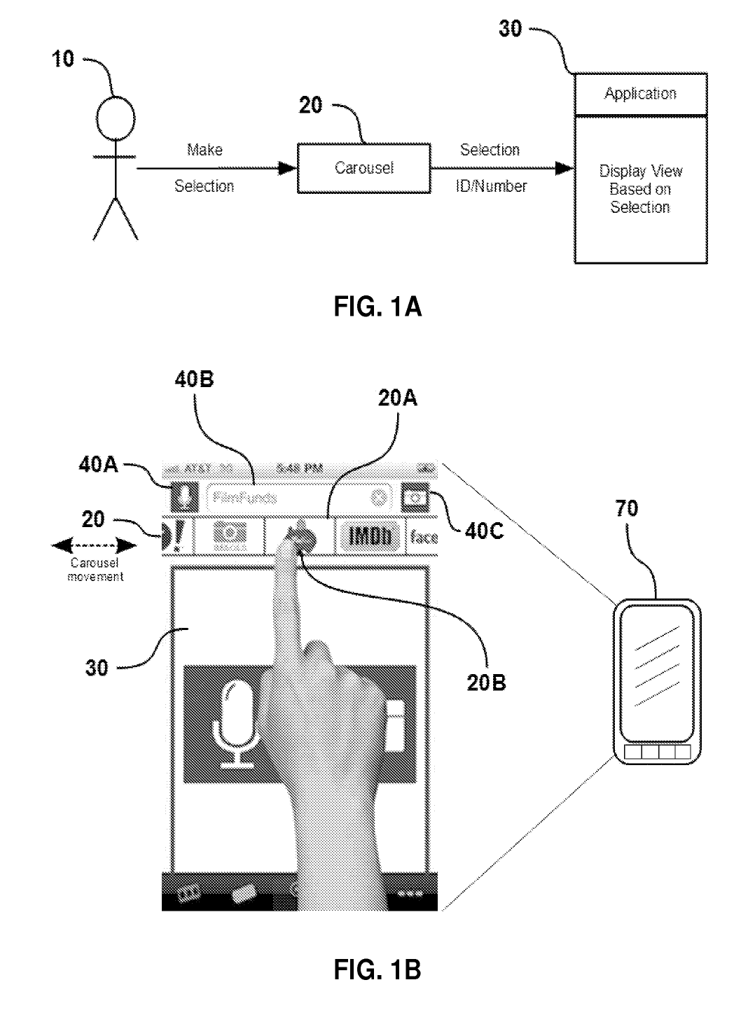

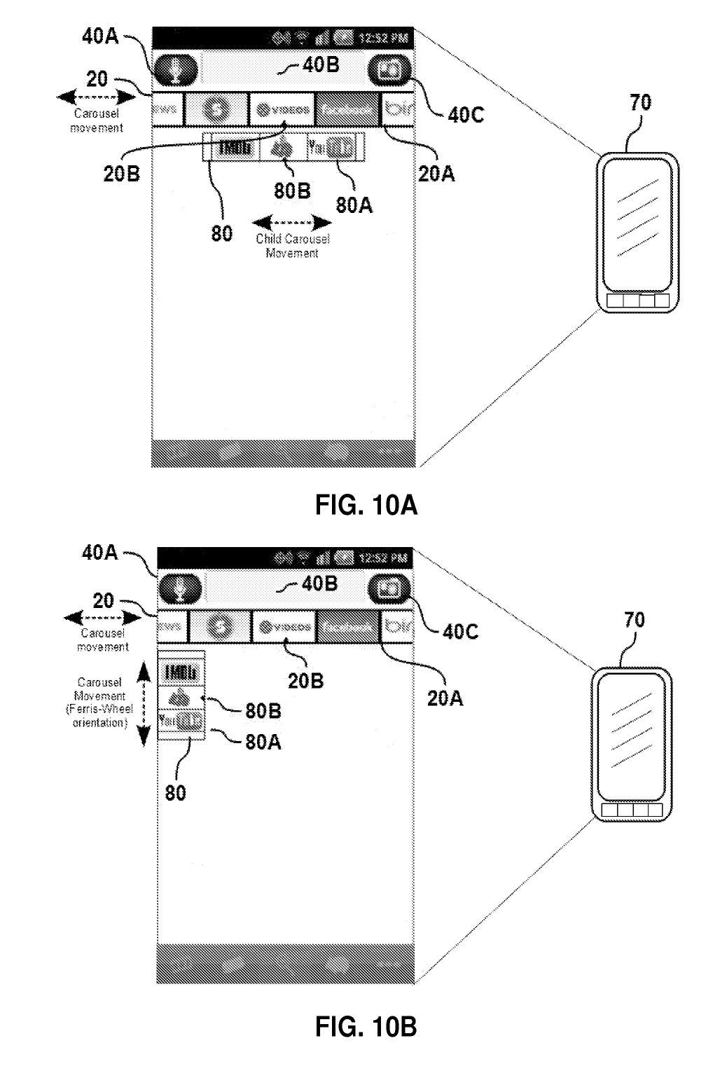

Refer to FIGS. 1A-10B. In an embodiment, the CSC 20 displays icons as search headers and is configurable within different executing platforms; e.g., mobile telephones/smart phones, tablets, laptops, and fixed-line products (PCs, etc.). The CSC 20 is especially adapted to small mobile-computing devices 70 that often have very small display/touch screens such that there is a very limited amount of display real estate to allocate to mobile-application navigation/functional tools such as pull-down menus, toolbars, and fields of functional icons that can often fill user screen without providing easy access to icons that could not be fit onto. The CSC 20 allows for a user to have easy access to a wide range of application options/functionality without having to navigate away from a main application 30 screen. In an embodiment, the CSC 20 can provide both direct and general data, dependent upon end-user configurations 25. In other variations, the CSC 20 can be adapted to interface with many third-party web services with a published API. In still other variations, the CSC 20 can operate within any appropriate computing framework/platform 30, 50, 60.

In still more embodiments, the CSC 20 can be enhanced to respond to image recognition 40C and/or voice recognition 40A, and to provide camera access to enable such facets as augmented reality (AR) technologies 40A-2, 40B-2, 40C-4, 40H, 50, 60.

In some embodiments, the CSC display 20 is comprised of a plurality of search icons 20A, the quantity of which is only dependent upon the capacity of the host unit (computing device, typically a mobile-computing device 70). However, for operational effectiveness and to illustrate a manageable scale (for the general querys), only primary search engines (also sometimes referred to in this disclosure as “search channels”) used in the art; e.g., Google, BING, Yahoo, etc.; are referred to herein.

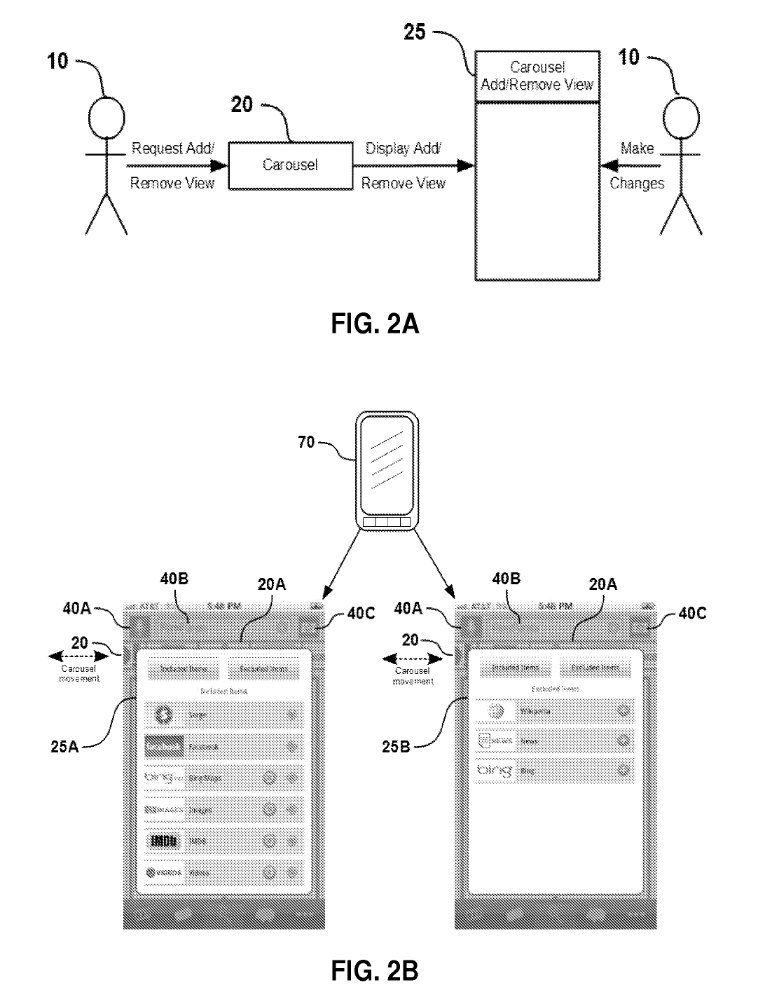

In many variations, the CSC can be configured based upon user personal preferences (see 25, FIGS. 2A-2B), and can be modified to suit any individual requirements. Such variations can include the incorporation of specific data supplied by specific companies or retailers in order to promote products from initial engagement through to commercial transaction.

In another embodiment, the CSC 20 method and search function 30 for searching a database of records organizes the results of a search into a set of most-relevant categories 20A for enabling a user's direct access to the information required. In response to a search instruction from the user in some variations, the CSC 20 search function searches the associated database, which can include Internet records and premium-content records, in order to generate a search-result list corresponding to a selected set of the records. In still more variations, the CSC 20 search function processes the search-result list to dynamically create a set of search-result categories 20A. Each such search-result category 20A is associated with a subset of the records within the search-result list having one or more common characteristics.

In an exemplary example of the implementation of the CSC 20 on a mobile-computing device 70, a user might initiate a specific search for a consumable product such as “coffee” or for an entertainment venue such as a theatre. In this case of “coffee”, the CSC in some embodiments would access a centralized database server 50, 60 containing related content assets and present specific details of the product and/or any related special offers. In the case of the entertainment venue, the CSC 20 would access a centralized database server to provide a user access to relevant locations, maps, and/or even tickets.

Returning to the “coffee’ example, in another variation an expanded mode of the CSC 20 configuration can enable keywords such as “coffee” to be programmable and returned as a search answer to a search query; for example, Starbucks® could own (within the configuration of the centralized content database system 50, 60, for instance) the term “coffee”, and as a result, each associated “coffee” query would be directed to Starbucks® and display precisely what Starbucks® would like their potential consumers to see. This facet is included to describe the scope of the CSC in relation to an associated back-end system 50, 60.

In yet another variation, the CSC 20 presents a new method and methodology for cross-platform browsing using CSC search facets 40, 40A, 40B, 40C in conjunction with the CSC toolbar 20. In some cases, the CSC 20 illustrates either brand names or logos 20A of popular brands, and the search can be through conventional methods such as touch screen or key pad/board. However, in the case of most smart phones, tablet computers, and the like, touch screens are used, sometimes in conjunction with a simulated keyboard 40B-1 on said touch screen. In many embodiments, the CSC application 20 has essential versatility in that the CSC application 20 can work in conjunction with manual interaction or through the facilities inherent within the user's computing device. Such versatility includes computing device's interal camera 40C, 40C-1 through 40C-4 (image recognition) or microphone (voice recognition) 40A, 40A-1 through 40A-2, 40D. In yet more embodiments, the CSC 20 is configurable by design and customer choice (see 25, FIGS. 2A-2B), though there are virtually an infinite number of configurations possible in terms of the varieties of brands or logos that are configurable within the CSC application 20. Moreover, manual typing of a URL (unique resource locator) is also possible in some variations.

While using the CSC 20 in an embodiment, by scrolling across the toolbar 20 in either direction, a choice of any service provider can be selected and automatic access to the web assets of that particular provider will be displayed. Apart from designated search icons 20A including assets, process-related items 20A can also be assigned to the toolbar 20 in some embodiments. A typical example of this might be direct access to a GPS-mapping environment, or any other associated proprietary or third-party designations.

In many embodiments, the execution of the CSC application by an end-user is via touch (mobile-computing devices 70, typically) and/or mouse (typically, a PC) for scrolling. In many embodiments, the CSC scroll bar can potentially contain content and/or icons associated with any designated search engine; for example, Google, BING, Yahoo, general-information facets such as Wikipedia, and/or social-media applications such as Facebook and Twitter. The CSC toolbar is customizable and there are numerous permutations which are limited only by the onboard memory of a user's computing device. In addition to this, any specific icon can include a customized logo that is configured to direct a user to a prescribed webpage. For example, in the “Starbucks” example discussed above, a mapping component could be included that could directly display directions to a location relative to the search (i.e., the exact location of a Starbucks coffee outlet nearby based on a mobile-computing device's 70 GPS-tracking information).

In still more embodiments, included within the CSC application is the provision of a direct link to an Augmented-Reality (AR) application, which enables content providers (especially advertisers) to demonstrate integrated, media-rich, three-dimensional and video AR presentations.

Overall, the CSC application can provide a unique, but configurable, user interface for conducting searches for information, while the CSC application (including its supporting back-end systems) can be adapted to provide specialized relevant content/information and vendor-specific advertizing to the end-user.

Refer to FIGS. 1A-10B, which help describe an overview of some embodiments of the CSC system architecture and process models.

### IV. Exemplary CSC Use-Case Processes

Refer to FIGS. 1A-10B. In an embodiment, a user 10 can interact with the CSC's Carousel 20 and Searchbar 40 in any order. There is no required sequence of steps for a user 10 to memorize. During interaction, a user 10 can interact with just the Carousel 20, just the Searchbar 40, or both the Carousel 20 and the Searchbar 40 in any order.

The following Use-Case Processes represent exemplary embodiments only, and are presented in an order a user 10 may typically follow to interact with all of the functionality of the CSC 20, but in many other embodiments, any of the listed Use-Case Processes may be followed independently of other processes. These Use-Case Processes contain interactions between a user 10 and the CSC 20, as well as between the CSC 20 and the application 30 containing the CSC 20.

a. Selection in the CSC Carousel

Refer to FIG. 1A, which depicts one embodiment of the interactive process required for a user 10 to make a selection in the Carousel 20, and which also includes the interaction between the Carousel portion 20 of the CSC and the containing application 30. Also, refer to FIG. 1B, which depicts one embodiment of a user's 10 selection of an icon 20A within the Carousel 20 with the user's finger interposed.

In a variation, a user 10 makes a selection in the Carousel 20 simply by touching or clicking on the selection (depending on the type of mobile-computing device 70, and the user-ipunt point technology used), which then rotates to the center position 20B of the Carousel 20. A user 10 can use a swiping motion to cause the Carousel 20 to rotate past several available selections 20A at a time. The entire set of available selections 20A in the Carousel 20 form a logical ring or circle. If the user 10 continues to rotate available selections 20A in the Carousel 20 in one direction, the last available selections 20A are followed by previously seen selections 20A that had disappeared from the user's 10 view in the direction opposite to the current motion of the Carousel 20.

In a variation, anytime a user 10 stops at a Carousel selection 20A, notification of the selection is sent to the enclosing application 30. In other variations, textual prompts appear on the user's display 30 that further define the meaning of an icon 20A that a user's finger is positioned over.

### B. Add/Remove Available Sections in the CSC Carousel

Refer to FIG. 2A, which depicts one embodiment of the interactive process between a user 10 and the CSC 20 to add or remove selections in the Carousel 20. Also, refer to FIG. 2B, which depicts one embodiment of an associated exemplary user screen. A user 10 has the option to add or remove specific selections 25 that are available in the Carousel 20. The software interaction is entirely contained within the CSC 20.

In variations, a user 10 requests the Add/Remove dialog 25 to be displayed by the Carousel 20 by applying a touch or press anywhere in the Carousel 20 for about 1.5 seconds. Of course, this time delay can be programmatically adjusted up or down in other embodiments, so long as the time delay is at least long enough to prevent inadvertent user 10 launch of said Add/Remove dialogue 25. The Add/Remove dialogue/view 25 is then displayed.

In another variation, the Add/Remove view is also based upon two tables, one listing items for inclusion on the carousel interface 20, and the other for exclusion from the carousel interface. In this variation, there are two buttons at the top of the dialogue 25 to allow a user 10 to toggle between the “Included Items” list 25A and the “Excluded Items” list 25B. Each item in the two respective lists have buttons that allow a user 10 to remove an item 20A from its respective list, which them places the item 20A into the other list.

In some embodiments, the Add/Remove view is based upon a table view having two sections: The upper section contains the selection items currently available to a user when viewing the Carousel, and the lower table section contains the selection items hidden from a user's view of the Carousel (and therefore, unavailable for selection). In a variation, removed selections 20A are not destroyed, but are stored by the CSC 20 for future inclusion in the Carousel 20 using the Add/Remove view 25. A user 10 can remove a selection 20A from those available in the Carousel 20A by dragging a selection from the upper part of the view to the lower part of the view. Conversely, any item in the lower section of the Add/Remove view 25, and thus hidden from the user in the Carousel 20, can be added or restored to the Carousel 20 by dragging it to the upper section of the Add/Remove view.

In additional embodiments, a user 10 can change the order of selection items 20A displayed in the Carousel 20. This is accomplished in the Add/Remove view 25 by dragging items within the table view 25A into the order preferred by a user 10.

Typically, in a variation, a user 10 uses the mobile-computing device's 70 back button to return to the main application 30 or in other cases, the dialogue 25 has a dedicated button (e.g., a “Done” button) for a user 10 to press or click to confirm and save the changes and return to the application 30.

### C. Enter-Text Search Button

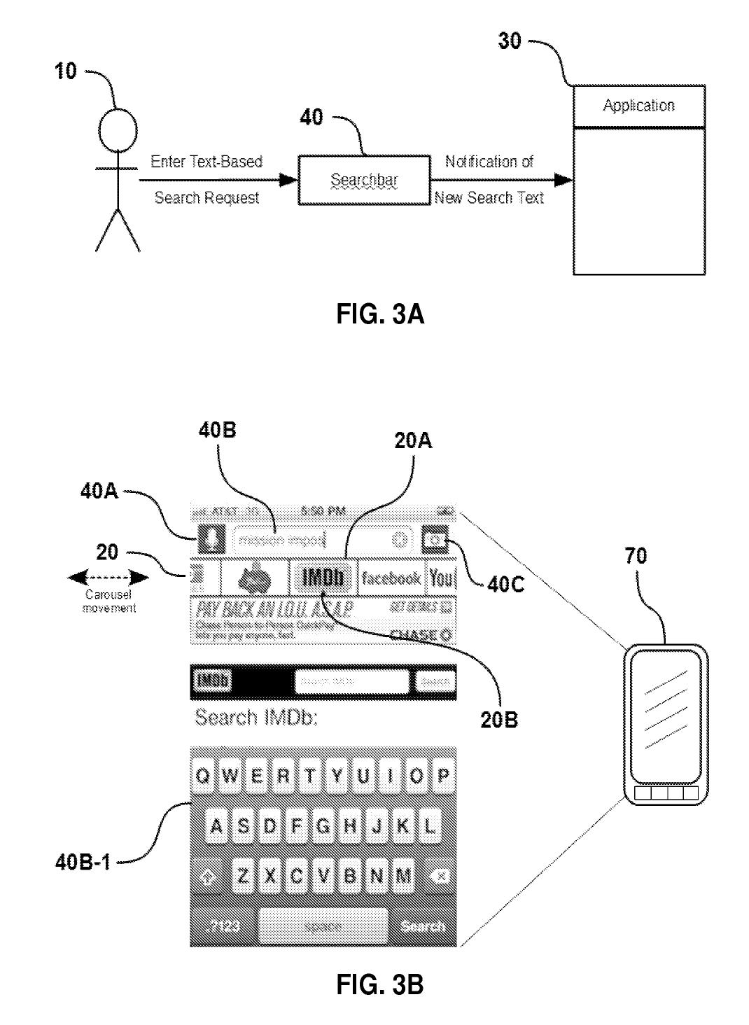

Refer to FIG. 3A, which depicts one embodiment of the process for user-text entering in the Searchbar for the purpose of causing the enclosing application 30 to search the preferred search platform as selected in the Carousel 20 using the user-entered search term. Also, refer to FIG. 3B, which depicts one embodiment of a user's CSC text-entry interface 40B.

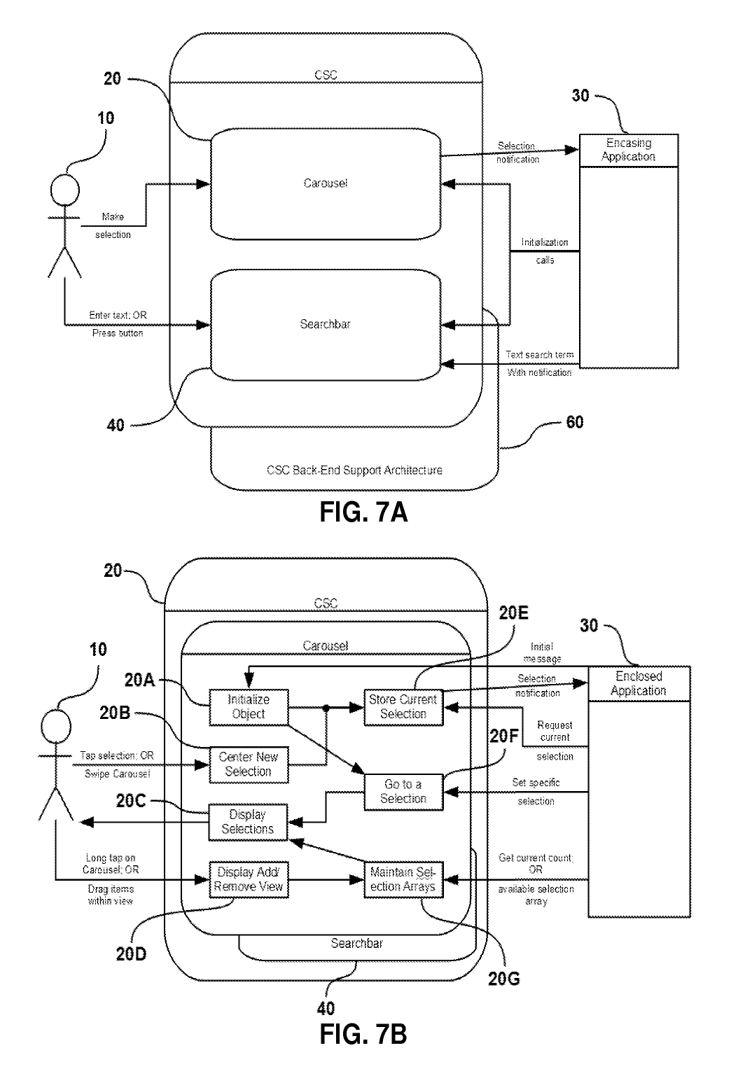

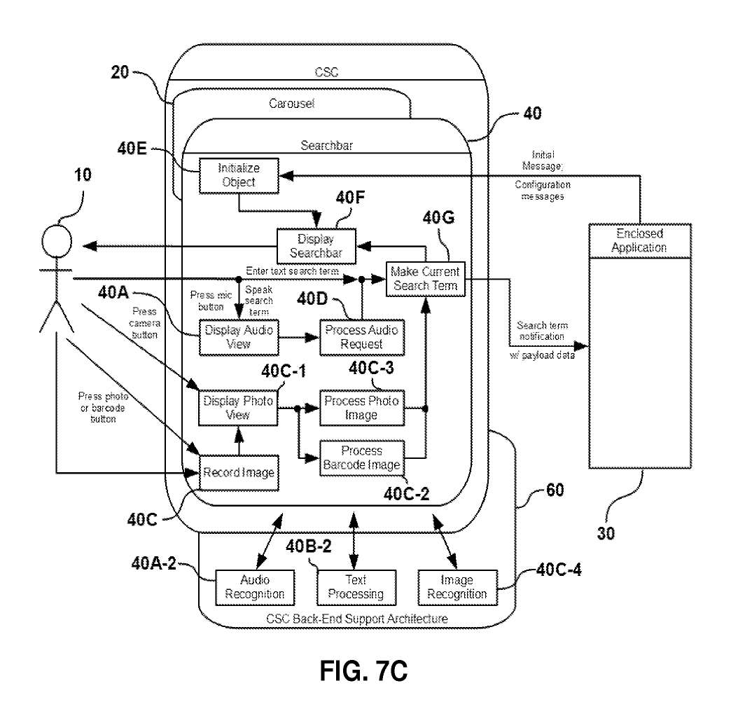

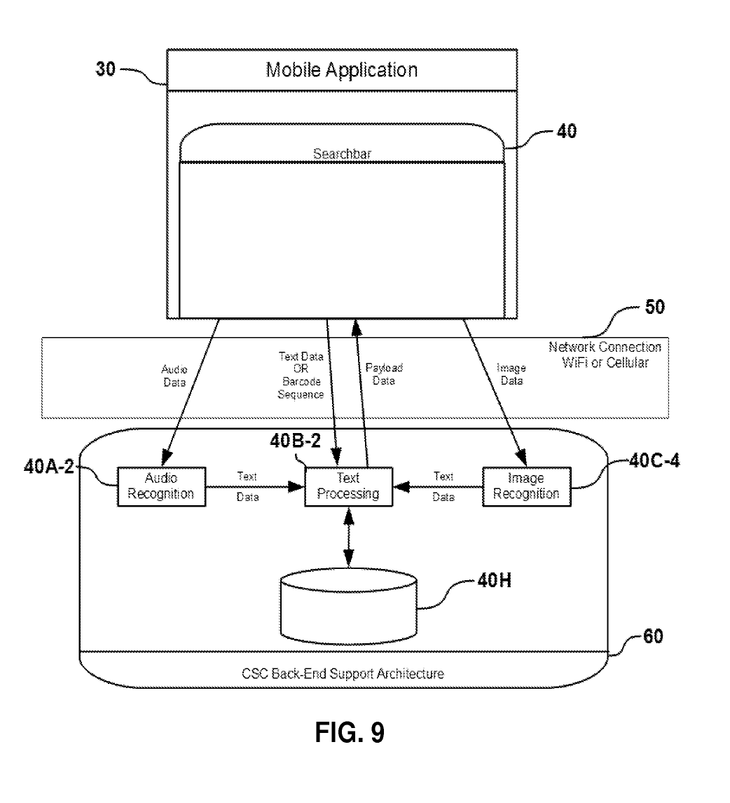

In a variation, a user 10 touches or clicks on the text field 40B in the Searchbar 40. If no hardware keyboard is available, then a virtual keyboard 40B-1 appears, which is then used by a user 10 to enter text. Pressing the Return key of the keyboard (virtual or hardware) causes the CSC 20 to accept the text entry. The new text entry is processed using the back-end architecture (see FIGS. 7C and 9; 60, 40B-2, 40H, 50), and notification is sent by the CSC 20 to the enclosing application 30 that a new text search item is available for processing. Typically, the enclosing application 30 will then use this new search text to perform a search on the search platform already selected 20A in the Carousel portion of the CSC 20.

### D. Speak Search Term

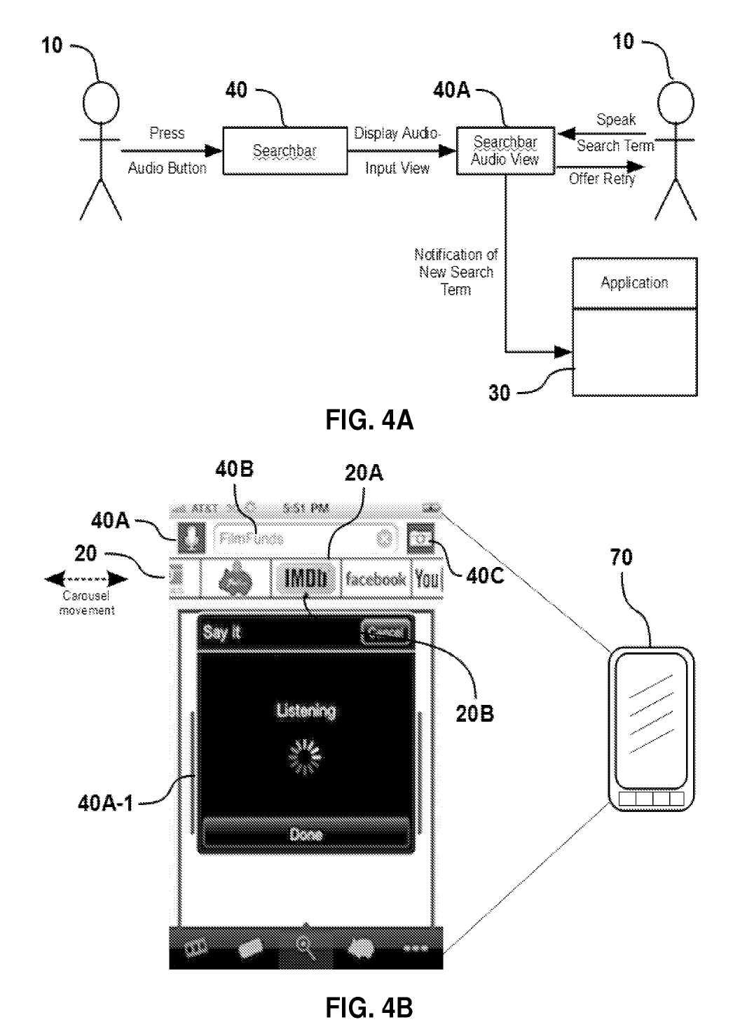

Refer to FIG. 4A, which depicts one embodiment of the interactive process required for a user 10 to enter a search term using spoken language for the purpose of causing the enclosing application 30 to search the preferred search platform as selected in the Carousel 20 using the user-spoken search term. Also, refer to FIG. 4B, which depicts one embodiment of a user's audio input interface 40A, 40A-1.

In some variations, a user 10 selects the Audio button 40A in the Searchbar 40 portion of the CSC 20, which causes the Audio-Input view 40A-1 to be displayed. The Audio-Input view 40B-1 prompts a user 10 to speak the desired search term. A Cancel button allows a user to cancel the entire process. Alternatively, in variations, the mobile-computing device's 70 “back” button may be used to exit the Audio-Input view 40A-1. The “Done” button on the Audio-Input view 40A-1 allows a user 10 to indicate that the user 10 has completed speaking the search term, assuming that the user 10 has used less than the programmatically maximum allowable time for input. In an embodiment, this predetermined time limit is typically approximately seven seconds (but in other embodiments can be varied), and is set to automatically begin processing spoken terms after the elapsed time.

In another variation, after either a user 10 presses the “Done” button or the maximum allowable time has elapsed, processing of the audio input begins via the enclosing application 30 and via the supporting back-end architecture (see FIGS. 7C and 9; 60, 40A-2, 40H, 50). In many embodiments, this processing requires a network connection 50 due to a requirement for back-end processing of audio input. When the audio processing is complete, the CSC 20 processes the returned results, determining that a text search term was derived from the audio input, or that the audio input was not intelligible and/or could not be processed into text search terms.

In some embodiments, a user 10 is prompted to choose amongst a list of candidate search terms that the CSC system 20 determined might correspond to a user-spoken search term that the system had trouble concretely identifying.

In a variation, if the audio input could not be processed into search terms, the user 10 is notified and provided a second opportunity to speak the search terms. The user 10 can either cancel or repeat this process. If text search terms are successfully processed from the audio input, then the text search terms are entered into the text field 40B of the Searchbar 40 for display, and the enclosing application 30 is notified that a new text search term is available for processing.

### E. Photograph Image for Search Term

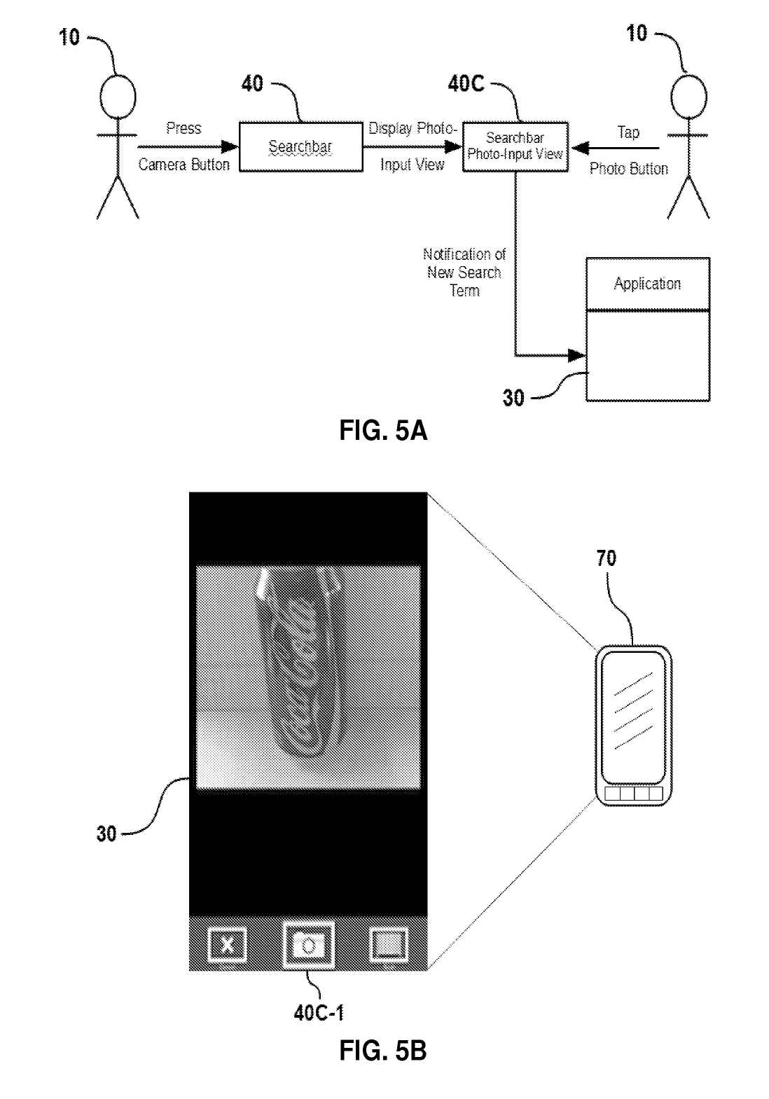

Refer to FIG. 5A, which depicts one embodiment of the interactive process required for a user 10 to enter a search term using an image for the purpose of causing the enclosing application 30 to search the preferred search platform as selected in the Carousel 20 using the derived search term. Also, refer to FIG. 5B, which depicts one embodiment of a user's photo input 40C, 40C-1 in the CSC 20.

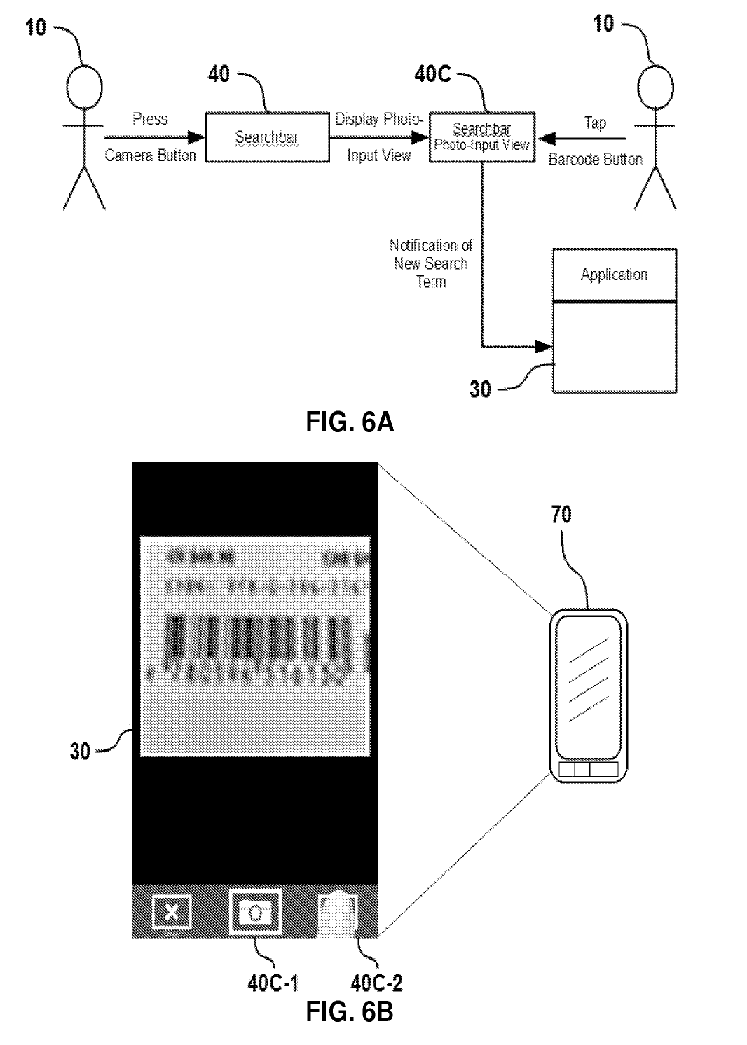

In an embodiment, a user 10 selects the Camera button 40C in the Searchbar 40 portion of the CSC 20. This causes the Photo-Input view 30 to be displayed. This view contains an image seen by the camera of the computing device 70 hosting the CSC application 30. The Photo-Input view 30 also contains a Cancel button, a Photo or Camera button 40C-1, and a Barcode button (see FIG. 6B; 40C-2). The Cancel button allows a user to cancel the entire process at any time prior to pressing on of the other buttons. A user 10 presses the Photo button 40C-1 to take a picture of the image as seen in this view.

According to some variations, pressing the Photo button 40C-1 causes processing of the photo input to begin via the enclosing application 30 and via the supporting back-end architecture (see FIGS. 7C and 9; 60, 40C-4, 40H, 50). In many embodiments, this processing requires a network connection 50 due to a requirement for back-end processing of photo input. The photo created when a user 10 presses the Photo button 40C-1 is sent over the network connection 50 to the back-end 60, 40C-4, 40H, 50, where image matching takes place for the purpose of identifying the image contents. When the photo processing is complete, the CSC 20 processes the returned results, determining that a text search term was derived from the photo input, or that no search term was derived due to the lack of an image match.

In another variation, if the photo input could not be processed into search terms, the user 10 is notified. If a text search term is successfully processed from the photo input, then the text search term is entered into the text field 40B of the Searchbar 40 for display, and the enclosing application 30 is notified that a new text search term is available for processing.

### F. Barcode Image for Search Term

Refer to FIG. 6A, which depicts one embodiment of the interactive process required for a user 10 to enter a search term using a barcode image for the purpose of causing the enclosing application 30 to search the preferred search platform, as selected in the Carousel 20, using the barcode-derived search term. Also, refer to FIG. 6B, which depicts one embodiment of a user's barcode input 40C, 40C-2 in the CSC 20.

In an embodiment, a user 10 selects the Camera button 40C in the Searchbar 40 portion of the CSC 20. This causes the Photo-Input view 30 to be displayed. This view contains an image seen by the camera of the device 70 hosting the CSC application 30. The Photo-Input view 30 also contains a Cancel button, a Photo or Camera button 40C-1, and a Barcode button 40C-2. The Cancel button allows a user 10 to cancel the entire process at any time prior to pressing on of the other buttons. A user 10 presses the Barcode button 40C-2 to take a picture of the image as seen in this view.

According to some variations, pressing the Barcode button 40C-2 causes processing of the photo input to be performed within the CSC 20. The photo created when the user-pressed Barcode button 40C-2 is processed to determine the numerical sequence represented by the barcode. When the barcode processing is complete, the returned results are used as the new search term. The numerical sequence is further processed by the back-end architecture to provide additional information.

In another variation, the text search term that results from the barcode processing is entered into the text field 40B of the Searchbar 40 for display, and the enclosing application 30 is notified that a new text search term is available for processing.

### V. CSC Data Flow

a. CSC Data Flow Overview

Refer to FIGS. 1A-10B. In many embodiments, the concept of the CSC 20 is implemented in two different and independent parts. One part is the Carousel 20, which provides for user-selection of a desired search platform, such as Google or IMDB. The second part is the Searchbar 40, which provides a user 10 with the interface for entering search terms as text, spoken word, photo image, or barcode image.

Refer to FIG. 7A, which provides a diagram of one embodiment of an overview of the CSC data flow, and which is intended to represent a top-level view of the relationships between a user 10, the CSC software 20, 40, the back-end support architecture 60, and the enclosing application 30. This data flow includes messages from the enclosing application 30 to the CSC 20, 40 needed to initialize the Carousel 20 and the Searchbar 40, as well as messages between software objects necessary to fulfill the functionality described in the exemplary use-case processes, described, supra, in Section IV. It should be noted that FIG. 7A is intended to be merely a general data-flow diagram. More-specific diagrams pertaining to messaging for the Carousel and the Searchbar are presented in FIGS. 7B and 7C.

### B. CSC Carousel Data Flow

Refer to FIG. 7B, which depicts one embodiment of the data flow associated with messaging between a user 10 and an enclosing application 30 via the Carousel 20.

In some embodiments, the enclosing application 30 must send a message to the Carousel 30 to initialize its configuration and content. The message sent to the Carousel 20 includes parameters defining images for the selections that will be in the Carousel 20. The image file names are used for identification by the Carousel 20 as well as the for the purpose of populating the Carousel 20 from the application 30 resources. All image file names both those initially available to the user 10 and those removed from the user's view—are supplied in an array 20G, while a second array contains the names of images that will be initially removed from a user's view.

In a variation, the CSC Carousel 20 initialization message includes an array 20G of friendly names; that is, a list of names for the available Carousel 20 selections that will be displayed to a user 10 in the Add/Remove view 20D. This message optionally contains an image representing the graphic that is the selection indicator, typically a simple pointer. In some implementations, this graphic is always positioned over the selection at the center 20B of the Carousel 20. When initialized, the CSC software will cause the Carousel 20 to display the selection designated as the home selection by one of the initialization parameters.

In still other variations, the primary functionality of the CSC Carousel 20 is to identify selections made by a user 10. When a user 10 taps (or clicks on) a specific selection, that selection automatically rotates to the middle 20B of the Carousel 20, indicating it is now the current selection 20E. A user 10 can also swipe the Carousel 20, causing the Carousel 20 to appear to spin and slow down until it stops and non-specific selection has come to rest in the middle 20B of the Carousel 20—somewhat like a roulette wheel, except that a user has only an edge-on view of the Carousel 20, and thus in most cases cannot see all of the plurality of available icons 20A in the Carousel 20 at the same time. The CSC functionality ensures that the selection is always centered 20B in the view. When a new selection has been made 20F, a notification 20E is sent to the enclosing application 30 of the new selection identifying the selection both by number and name.

In an embodiment, the enclosing application 30 can send a message to the CSC Carousel 20 at any time to request the current selection 20E by name or number, or request a count of selectable items, or request an array containing the names of all selectable items. In another variation, the enclosing application 30 can also send a message to the Carousel 20 setting the selection 20F to a specific item by name or number.

In yet more variations, a user 10 can press anywhere in the Carousel 20 for about 1.5 seconds or (or some other predetermined period of time) in order to alert the Carousel 20 that he or she wishes to change the items available in the Carousel 20, or to rearrange the order of items in the Carousel 20. (Of course, in some implementations, this time setting/sensitivity can be varied programmatically and/or by user-preference settings.) The long press by a user 10 causes the Carousel 20 to display the Add/Remove view 20D (see Section IV.B, supra). In variations, a user 10 can move items between sections of this view in order to add or remove selection items from the viewable Carousel 20 or can drag items within a section of the Add/Remove view 20D to reorder the available selections.

In an embodiment, when a user 10 has completed any changes and dismisses the Add/Remove view 20D, the changes in available selections and their order are processed and displayed 20C for the user 10. These changes are also stored, so that subsequent launches of the application 30 will result in the display of selections as intended by the user 10.

### C. CSC Searchbar Data Flow

Refer to FIG. 7C, which depicts one embodiment of the data flow associated with messaging between a user 10 and an enclosing application 30 via the Searchbar 40.

In some embodiments, the enclosing application 30 must send a message to the Searchbar 40 to initialize its configuration and content. The message sent to the Searchbar 40 includes a parameter for the rectangle defining the area in which to display the Searchbar 40. In many variations, additional messages can be sent to the Searchbar 40 to define background color, text font in the text field, text size, text color, and other text-field attributes.

In an embodiment, the primary function of the Searchbar 40 is to allow a user 10 to input search-term requests using text input, audio input, photo-image input, or barcode-image input. Following initialization, the initial search term is displayed in the text field of the Searchbar 40 (see Section IV.C, supra). A user 10 can then tap on the text field to input a new search term 40G using the keyboard/keypad (physical or virtual). After entering the text, the new search term is designated as the current search term by the executing software 40G. The new search term is then sent to the CSC 20 back-end architecture 60, 40A-2, 40B-2, 40C-4 for processing, and a “payload” is returned to the Searchbar 40, which contains processed text information. A notification is then caused to be sent to the enclosing application 30. Attached to the notification is the “payload”, which contains the new search term 40G. If no network connection is available, then a “failed” payload is sent with the notification to the enclosing application 30.

In other variations, a user 10 can input an audio search term using the Searchbar 40, 40A, 40D. After tapping the microphone button, the Audio-Input view 40A is displayed (see Section IV.D, supra), allowing a user 10 to interact to provide audio input. The audio input is processed 40D by sending it to the CSC back-end architecture 60, 40A-2 for processing. Following this processing, a payload is returned to the Searchbar 40. This payload contains status information along with the results of the audio input translated to text, and this text becomes the current search term 40G. If the translation fails, the payload contains failed status data. If no network connection is available, a failed payload is created. The notification with attached payload is then sent to the enclosing application 30.

In still another variation, a user 10 can elect to input a photo-search term using the Searchbar 40, 40C. After tapping the camera button, the Video-Input view 40C-1 is displayed (see Section IV.E, supra), allowing a user 10 to take a photo. The image input is processed 40C-3 by sending it to the CSC back-end architecture 60, 40C-4 for processing. Following this processing, a payload is returned to the Searchbar 40. This payload contains status information along with the results of the image identification and metadata for that image. The metadata is designated by the system as the current search term 40G. If the translation fails, then the payload contains failed status data. If no network connection is available, then a failed payload is created. The notification with attached payload is then sent to the enclosing application 30.

In yet more embodiments, a user 10 can elect to input a barcode search term using the Searchbar 40, 40C. After tapping the camera button, the Video-Input view 40C-1 is displayed displayed (see Section IV.F, supra), allowing the user to take a photo of a barcode. The barcode input is processed internally 40C-2 to turn the barcode into a barcode numerical sequence. As for text input, the barcode numerical sequence becomes the current search term 40G. It is also sent to the CSC back-end architecture 60, 40C-4 for processing. Following this processing, a payload is returned to the Searchbar 40. This payload contains status information along with processed text information for the barcode numerical sequence. If the translation fails, then the payload contains failed status data. If no network connection is available, a failed payload is created. The notification with attached payload is then sent to the enclosing application 30.

### VI. CSC Software and Supporting Back-End Software Descriptions

### A. General

In many embodiments, the CSC software is used within applications requiring this functionality for the intended user. The CSC software provides all of the functionality described in Section IV, supra, with the exception of functionality provided by “back-end” software run on a server and connected to the CSC software via a network connection. In many embodiments, the CSC software does not in itself provide the functionality of a complete application, but is intended to be part of a complete application; that is, a “plug-in” module that adds such functionality to the enclosing “complete” application.

### B. CSC Carousel Classes

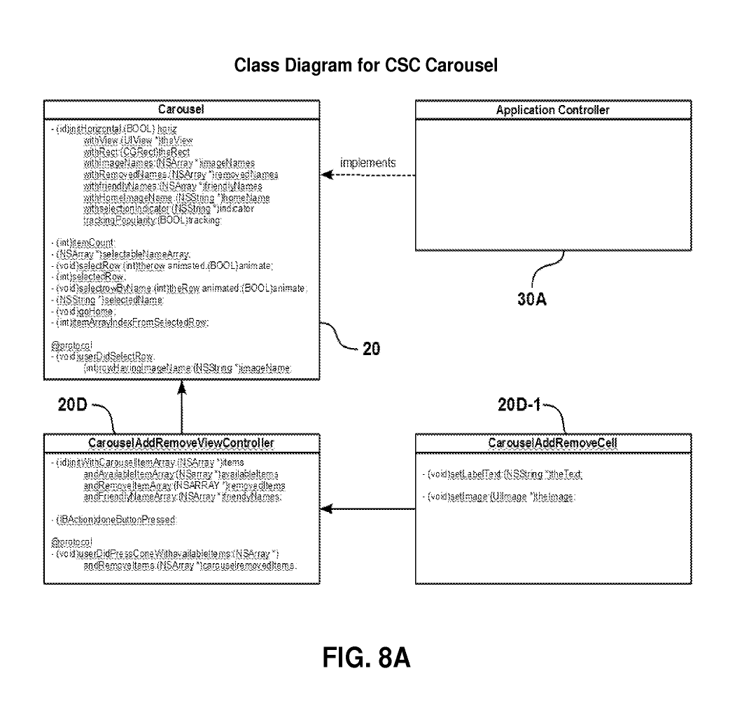

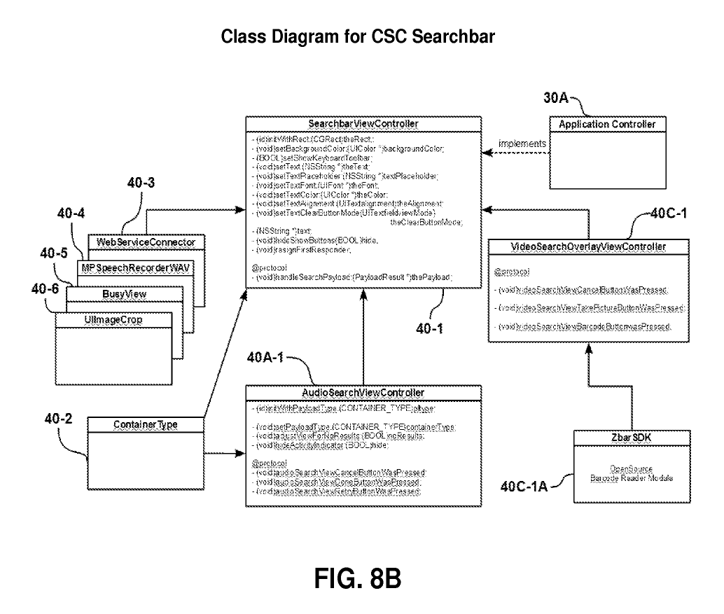

Refer to FIG. 8A, which depicts one embodiment of the class definitions and dependencies in support of the implementing software for the CSC Carousel. The solid arrows indicate classes imported into other classes. The class being pointed to by the arrow is the class performing the import and instantiating the base class. The dotted arrow lines illustrate the class that is implementing another class.

In a variation, each box in FIG. 8A that depicts a class identifies the public methods for that class using Objective-C notation. A plus sign at the beginning of a method indicates a class method, and a minus sign indicates an instance method.

In an embodiment, the CSC Carousel is described in three classes. There are no other dependencies outside these three classes with the exception of the system-level classes on which all applications depend for a given platform. In the case of the Carousel implemented for iOS on the iPhone and iPad, in one embodiment, the Carousel is dependent on Apple's classes/frameworks UIKit and QuartzCore. Of course, one ordinarily skilled in the art would appreciate the need to adapt the Carousel core classes to interact with the system-level classes on other platforms; e.g., Windows, Android, etc.

In one embodiment, the primary class for the CSC Carousel is the class Carousel 20. This class contains the visual Carousel, as well as arrays containing the images used to populate the Carousel. This class is implemented by a controller class 30A belonging to the application implementing the CSC Carousel.

In an embodiment, the class Carousel 20 has methods for initializing the instance, fetching arrays of selectable items, getting and setting the selected row by number or by name, and going to certain locations. This class has one protocol delegate method, which must be implemented by the implementing class. This delegate method is called when the user makes a new selection in the Carousel.

In another variation, class Carousel 20 is dependent on one class, which it implements. This is the CarouselAddRemoveViewController 20D, which provides the visual interface necessary for the user to be able to add, remove, and re-arrange items available in the Carousel. This class 20D has two instance methods; the first is executed for the initialization of this class as an object, while the second is executed when a user presses the “Done” button in the visual Add/Remove interface.

In more variations, the CarouselAddRemoveViewController class 20D is in turn dependent on one class which it implements, called the CarouselAddRemoveCell 20D-1. Class CarouselAddRemoveCell 20D-1 is implemented when an instantiation of CarouselAddRemoveViewController 20D is building the table used to visually display the Carousel items, and is necessary to implement individual cells within that table. Class CarouselAddRemoveCell 20D-1 has two instance methods used to set the text in the cell's label, and set the image for a given cell.

### C. CSC Searchbar Classes

Refer to FIG. 8B, which depicts one embodiment of the class definitions and dependencies in support of the implementing software for the CSC Searchbar. The solid arrows indicate classes imported into other classes. The class being pointed to by the arrow is the class performing the import and instantiating the base class. The dotted arrow lines illustrate the class that is implementing another class.

In a variation, each box in FIG. 8B that depicts a class identifies the public methods for that class using Objective-C notation. A plus sign at the beginning of a method indicates a class method, and a minus sign indicates an instance method.

In an embodiment, the CSC Searchbar is described in three primary classes, plus a number of secondary and tertiary dependencies. As for the Carousel implemented in iOS, the Searchbar is dependent on Apple's classes/frameworks UIKit and QuartzCore as well as Foundation. Of course, one ordinarily skilled in the art would appreciate the need to adapt the Carousel core classes to interact with the system-level classes on other platforms; e.g., Windows, Android, etc.

In a variation, the primary class for the CSC Searchbar is SearchbarViewController 40-1. This class contains the visual searchbar, and is implemented by a controller class belonging to the application. SearchbarViewController 40-1 has methods for initializing this class, setting characteristics for the text in the text search field, capturing the text contained in the text search field, and modifying the appearance of the Searchbar, including the hiding/showing of the microphone and camera buttons. This class has one protocol delegate method, which must be implemented by the implementing class. This class is called when a user has requested a search, as well as when the search has been processed and a payload is available, including payload data provided by the back-end architecture. The delegate is called to process this payload.

In some embodiments, class SearchbarViewController 40-1 is dependent on a primary class called VideoSearchOverlayViewController 40C-1, which it implements. When a user taps/clicks on the camera in the Searchbar, class SearchbarViewController 40-1 uses standard system classes and methods to provide a camera view for the user. The VideoSearchOverlayViewController 40C-1 class provides an overlay on top of the standard camera view in order to have custom buttons the user can tap/click to cancel the view, take a picture of the camera view for image processing, and take a picture of a barcode for processing. In support of these three buttons are three protocol delegate methods which are implemented by the implementing class, SearchbarViewController 40-1. These delegate methods allow SearchbarViewController 40-1 to respond to button taps on buttons provided by the VideoSearchOverlayViewController 40C-1.

In more variations, class VideoSearchOverlayViewController 40C-1 is in turn dependent a secondary class/framework that it implements called ZbarSDK 40C-1A. ZbarSDK is an Open-Source set of classes that are responsible for processing an image of a barcode into a barcode numerical sequence.

In other variations, a second primary class on which SearchbarViewController 40-1 is dependent is called AudioSearchViewController 40A-1. When a user clicks on the microphone in the Searchbar, class SearchbarViewController 40-1 implements class AudioSearchViewController 40A-1 to present the view allowing a user to speak a desired search term. The AudioSearchViewController 40A-1 class has four instance methods that are used to instantiate an instance of the class and set it up for use. There are three protocol delegate methods which are implemented by the implementing class, SearchbarViewController 40-1. These delegate methods allow SearchbarViewController 40-1 to respond to button taps in the audio view by processing the audio input.

In an additional embodiment, class AudioSearchViewController 40A-1 is in turn dependent on a number of secondary and tertiary classes. These secondary classes include ContainerType 40-2, which is also implemented by SearchbarViewController 40-1. The other secondary classes are WebServiceConnector 40-3, MPSpeechRecorderWAV 40-5, BusyView 40-6, and UIImageCrop 40-6. These classes provide services, such as network connections, image handling, and the recording of the audio input. It should be noted that some of these secondary/teriary classes are in turn dependent on additional tertiary classes not depicted here. In variations, some of those classes are Open-Source.

### D. CSC Back-End Archtecture

Refer to FIG. 9, which depicts one embodiment of the basic components of the back-end CSC-supporting system architecture. The back-end architecture supports the CSC through the Searchbar object 40.

In an embodiment, the back-end architecture 60 includes segments for processing audio 40A-2, video 40C-4, and text 40B-2 data input. The type of data sent to this back-end is dependent on the type of input provided by a user. For example, if a user has provided text input using the text search field or has taken a picture of a barcode, then text data or a barcode numerical sequence 40B-2 is sent to the back-end 50, 60 for processing. Similarly, if a user has provided a spoken search term, then audio data 40A-2 is sent to the back-end 50, 60, and if a user has taken a picture of a non-barcode image, image data 40C-4 is sent to the back-end 50, 60.

In variations, text data and barcode numeric sequences are sent to the applications in the back-end 70 responsible for processing text 40B-2. Text-matching allows for the search of data bases for data used to build the payload, which is data returned to the mobile application 30 for processing and display to a user.

In other variations, audio data sent 40A-2 to the back-end 50, 60 goes through applications designed to translate the audio data into text as spoken by the user. This text is used as the search term, and so is sent to the text processing applications for text matching and the building of payload data.

In even more embodiments, image data 40C-4 sent to the back-end 50, 60 goes through special applications that identify the image contents. Special image data bases 40H match the identified image with associated text based meta-data. This metadata becomes the text data sent to the text processing in the back-end 50, 60. Just as for text data and audio data, the payload data is build from this text data, and then retuned to the mobile application 30.

In yet more variations, the CSC application/system described, supra, is supported by a cloud server 50, 60 to achieve maximum functionality, scalability, and maintainability. The CSC system can utilize a combination of automated deployment scripts and server role scripts. The majority of the deployments are handled using a suite of scripts run by a control panel, which position package repositories and system partitions.

### VII. CSC Application Programming Interface (API)

In many embodiments, the CSC, as described in various embodiments, supra, can be delivered in the form an Application Programming Interface (API) that is agnostic across several popular operating systems, both fixed and mobile. In variations, the API can be downloaded from a pre-described website; Session Description Protocol (SDP) Offer/Answer (O/A) (bandwidth permitting), plug-in, and/or through disk or associated hardware.

In many embodiments, the CSC application employs a web-service interface. A general-purpose example of the implementation of the CSC makes use of an API to initiate the CSC application and methods. The API is introduced as a general-purpose application and provides both a user interface for the mobile transceiver whilst connecting specific links into general-purpose servers. Another embodiment of the CSC implements a process that provides a path for commerce directly through a link between servers and a mobile transceiver. No third-party intervention (other than the advertiser) is implied, in that the product provides a direct connection to the product which the consumer wants to buy.

In still more embodiments, the interface represents a configuration of compiled data, which interacts with wireless networks and (if necessary) with internally hosted servers, which correspond with mobile devices through multiple-access coding channels. Similarly, a laptop and PC interface can use the proprietary API (application programming interface). Channels can be allocated primarily for proprietary applications.

### VIII. CSC Portability

In most embodiments, the CSC application is compatible with mobile standards and can utilize available bandwidth across all mature networks. The CSC application works on advanced 3G and conventional 4G networks, and complies with LTE (Long-Term Evolution) standards. In addition, a distinct characteristic of the CSC system, in some embodiments, is that it can be transferred almost seamlessly between mobile, laptop, and fixed-wire PC. In still more embodiments, the CSC application can be adapted to operate within multiple operating systems that access directly focused user enquiries as the subsequent result of a vision recognition, voice recognition, or typed enquiry.

In mobile application embodiments, the CSC application essentially incorporates the functions of a fixed-line web tool; however, certain considerations are given in terms of memory size, computational power, battery life, and screen size. Nevertheless, the process for scrolling, search, and choice are fundamentally the same between mobile and fixed-line embodiments of the CSC application.

Further, in many embodiments, users are able to use configuration tools to customize fixed-line web application principles onto a mobile platform. In certain cases, the CSC application is adapted to support media-rich AR applications.

In another embodiment, the CSC application works in conjunction with a proprietary algorithm, which operates agnostically across several mobile platforms. The algorithm is designed to function with the majority of popular embedded codes.

In variations, the CSC system can be used as a search tool predicating a wide variety of interactions with other mobile, laptop, and PC applications. This includes applications involving image recognition, voice recognition, and/or direct access through typing and touch pad facilities.

Within a compatible configuration, in some embodiments the CSC system can provide the user with an option to employ additional services as described, supra, using directly appointed servers or general TCP/IP (transmission control protocol/internet protocol).

In some embodiments, the CSC system is compatible with TCP/IP (transmission control protocol/internet protocol), WiFi (Wireless local area network Wireless fidelity IEEE 802.11), 3G (3rd Generation WCDMA network incorporating HSDPA—High-Speed Data Packet Access and UTMS—universal mobile telephone system) and can be adapted to generally almost any information-transfer protocol as such standards and protocols are developed in the future. Further, in many embodiments, the CSM system is compatible with proprietary GSM standards essentially utilizing EDGE (Enhanced Data Rates for GSM).

Moreover, in still more variations, the CSC system is compatible with new version 4G handsets incorporating OFDMA (Orthogonal Frequency Division Multiple Access) and MIMO (Multiple In-Multiple Out), and antennae. In addition, it is compatible with wired applications such as ISDN (International Standard Data Network), and any associated hard-wire applications. The unique portability of the CSC application enables the application to be functional (in fact improved) though the long-term evolution (LTE standard) of mobile telephony.

### IX. A Software-Based Graphical Toolbar Used within a Mobile-Computing Application

Refer to FIGS. 1A-10B. This embodiment is generally directed to a graphical toolbar 20 used in conjunction with an associated mobile-computing application operating on a mobile-computing device 70 (such as, for example, a mobile phone, smart phone, table computer, and the like). The mobile-computing device 70 typically has a touch screen for user input; however, other devices that use other point-and-select means (e.g., a Blackberry® trackball-and-button scheme) are contemplated as being encompassed within the scope of the embodiments and variations that refer to touching/selecting/pressing features on an application display.

In the present embodiment, the graphical tool bar 20 comprises a plurality of icons 20A that are logically linked such that a logical circle of icons is formed, wherein:
Each of the plurality of icons 20A represents a discrete functional capability associated with a different information-search channel;
The logical circle is graphically presented as an edge-on view of a carousel interface 20 within an associated mobile-computing application 30, in order to minimize the amount of user-screen area taken-up by the carousel interface 20 to maximize the user-screen area available for other mobile-computing-application 30 functionality;
The carousel interface 20 is adapted such that a subset of the plurality of icons 20A is displayed at any one time, and each of the displayed icons 20A is user-selectable;
The carousel interface 20 is adapted to allow a user 10 to scroll the Carousel 20 in either direction to display and/or select additional icons 20A; and
Each of the plurality of icons 20A, when selected by a user 10, is adapted to provide added predetermined functionality and information to a user 10 via the balance of an associated mobile-computing application 30.

This embodiment can be further enhanced wherein when any of the plurality of icons 20A is selected by a user 10, the carousel interface 20 is programmatically caused to center the selected icon 20B within the viewable part of the carousel interface 20.

This embodiment can be further enhanced wherein the edge-on view of the carousel interface 20 is oriented and rotated relative to a user's 10 view of the user's mobile-computing device 70 display screen by an orientation of either substantially horizontal or substantially vertical.

This embodiment can be further enhanced wherein the information-search channel of each of the plurality of icons 20A represents an Internet-search engine different than at least one of the other icons 20A within the carousel interface 20. In variations, the information-search channel of each of the plurality of icons 20A represents a premium channel reserved for a commercial entity to provide targeted user-search results to a mobile-computing device such that the commercial entity's business interests are promoted while providing information to a user 10. In still more variations, the premium channel results from a given commercial entity paying consideration to the provider of an associated mobile-computing application 30 in order to reserve a channel that is associated with one or more key search terms. In some cases, the commercial entity reserves one or more key search terms and the associated premium channel by renting/leasing or purchasing.

This embodiment can be further enhanced wherein at least one of said plurality of icons 20A represents a functional process related to at least one user-inputted search term, and wherein a user 10 can launch that functional process by selecting the associated icon 20A on the carousel interface 20.

This embodiment can be further enhanced wherein at least one of the plurality of icons 20A represents a functional process that, when selected, launches an augmented-reality application to provide media-rich content, related to the at least one user-inputted search term, back to a mobile-computing device 70.

This embodiment can be further enhanced wherein the graphical-toolbar application further comprises a toolbar-management module 25, the module 25 being launchable by a user 10 by applying a touch or press anywhere on the carousel interface 20 for in excess of a predetermined time, and when launched, displays a user dialogue comprised of:
A first section displaying icons 20A currently available to a user 10 when viewing the carousel interface 20;
A second section displaying other icons 20A not currently available for selection by a user 10 on the carousel interface 10;
A means to allow a user to switch between the first and second sections 25A, 25B;
In the first section 25A, a means for a user 10 to select a displayed icon 20A and cause the selected icon 20A to be removed from the first section 25A and simultaneously added to the second section 25B;
In the second section 25B, a means for a user 10 to select a displayed icon 20A and cause the selected icon 20A to be removed from the second section 25B and simultaneously added to the first section 25A; and
A means for a user 10 to save any user-changes made and exit the user dialogue 25.

This embodiment can be further enhanced wherein the graphical-toolbar application 20 further comprises the capability of launching a child toolbar 80 when a predetermined icon 20A is selected by a user 10, the child toolbar 80 comprising a second plurality of icons 80A that are logically linked such that a logical circle of icons is formed, wherein:
Each of the second plurality of icons 80A represents a discrete functional capability associated with a different information-search channel or functionality;
The logical circle is graphically presented as an edge-on view of a second carousel interface 80 within an associated mobile-computing application 30, in order to minimize the amount of user-screen area taken-up by the second carousel interface 80 to maximize the user-screen area available for other mobile-computing-application 30 functionality;
The second carousel interface 80 is adapted such that a subset of the second plurality of icons 80A is displayed at any one time, and each of the displayed icons 80A is user-selectable;
The second carousel interface 80 is adapted to allow a user 10 to scroll the second carousel 80 in either direction to display and/or select additional icons; and
Each of the second plurality of icons 80A, when selected by a user, is adapted to provide added predetermined functionality and information to a user via the balance of an associated mobile-computing application.

This embodiment can be further enhanced wherein the second carousel interface 80 is oriented substantially orthogonally relative to its parent graphical toolbar 20. In a sense, the edge-n view of the child “carousel” 80 can be thought of, instead, as an edge-on view of a “Ferris Wheel”, with the ideal placement to one of the extreme sides of the mobile-computing device 70 display screen in order to maximize the amount of remaining display real estate to be used by the associated mobile-computing application 30. Alternatively, in another variation, the second carousel interface 80 is oriented substantially in parallel relative to its parent graphical toolbar 20, with the ideal placement immediately adjacent to the parent carousel interface 20 in order to maximize the amount of remaining display real estate to be used by the associated mobile-computing application 30.

This embodiment can be enhanced by further comprising a multi-input searchbar 40, said searchbar 40 graphically located either above or below, and proximal to, the carousel interface 20, wherein:
The searchbar 40 has a text-input section 40B and launchable program module programmatically coupled to an associated mobile-computing application 30;
The searchbar 40 has an audio-input section 40A and launchable program module programmatically coupled to an associated mobile-computing application 30; and
The searchbar 40 has an image-capture-input section 40C and launchable program module programmatically coupled to an associated mobile-computing application 30.

This enhancement can be varied wherein the carousel interface 20 is adapted to be dynamically populated with said plurality of icons 20A after a user 10 initiates a search via the searchbar 40, the plurality of icons 20A reflecting information channels and/or functionality according to the results of a user-initiated search. In addition, this enhancement can be varied wherein the graphical toolbar 20 is adapted such that a user 10 can select an information-search channel 20A from the carousel interface 20, then initiate a search via the searchbar 40 and associated mobile-computing application 30, wherein the search results are limited to the selected information-search channel 20A. Further, this enhancement can be varied wherein the audio-input section 40A is adapted to receive voice-command inputs via a mobile-computing device's 70 microphone, and/or wherein the image-capture-input section 40C is adapted to receive inputs via a mobile-computing device's 70 camera.

### X. A Method of Making Software-Based Graphical Toolbar Used within a Mobile-Computing Application

Refer to FIGS. 1A-10B. This embodiment is generally directed to a method of making graphical toolbar 20 used in conjunction with an associated mobile-computing application operating on a mobile-computing device 70 (such as, for example, a mobile phone, smart phone, table computer, and the like). The mobile-computing device 70 typically has a touch screen for user input; however, other devices that use other point-and-select means (e.g., a Blackberry® trackball-and-button scheme) are contemplated as being encompassed within the scope of the embodiments and variations that refer to touching/selecting/pressing features on an application display.

In the present embodiment, the method comprises the step of providing a plurality of icons 20A that are logically linked such that a logical circle of icons is formed, wherein:
Each of the plurality of icons 20A represents a discrete functional capability associated with a different information-search channel;
The logical circle is graphically presented as an edge-on view of a carousel interface 20 within an associated mobile-computing application 30, in order to minimize the amount of user-screen area taken-up by the carousel interface 20 to maximize the user-screen area available for other mobile-computing-application 30 functionality;
The carousel interface 20 is adapted such that a subset of the plurality of icons 20A is displayed at any one time, and each of the displayed icons 20A is user-selectable;
The carousel interface 20 is adapted to allow a user 10 to scroll the Carousel 20 in either direction to display and/or select additional icons 20A; and
Each of the plurality of icons 20A, when selected by a user 10, is adapted to provide added predetermined functionality and information to a user 10 via the balance of an associated mobile-computing application 30.

This embodiment can be further enhanced wherein when any of the plurality of icons 20A is selected by a user 10, the carousel interface 20 is programmatically caused to center the selected icon 20B within the viewable part of the carousel interface 20.

This embodiment can be further enhanced wherein the edge-on view of the carousel interface 20 is oriented and rotated relative to a user's 10 view of the user's mobile-computing device 70 display screen by an orientation of either substantially horizontal or substantially vertical.

This embodiment can be further enhanced wherein the information-search channel of each of the plurality of icons 20A represents an Internet-search engine different than at least one of the other icons 20A within the carousel interface 20. In variations, the information-search channel of each of the plurality of icons 20A represents a premium channel reserved for a commercial entity to provide targeted user-search results to a mobile-computing device such that the commercial entity's business interests are promoted while providing information to a user 10. In still more variations, the premium channel results from a given commercial entity paying consideration to the provider of an associated mobile-computing application 30 in order to reserve a channel that is associated with one or more key search terms. In some cases, the commercial entity reserves one or more key search terms and the associated premium channel by renting/leasing or purchasing.

This embodiment can be further enhanced wherein at least one of said plurality of icons 20A represents a functional process related to at least one user-inputted search term, and wherein a user 10 can launch that functional process by selecting the associated icon 20A on the carousel interface 20.

This embodiment can be further enhanced wherein at least one of the plurality of icons 20A represents a functional process that, when selected, launches an augmented-reality application to provide media-rich content, related to the at least one user-inputted search term, back to a mobile-computing device 70.

This embodiment can be further enhanced by further comprising the step of providing a toolbar-management module 25, the module 25 being launchable by a user 10 by applying a touch or press anywhere on the carousel interface 20 for in excess of a predetermined time, and when launched, displays a user dialogue comprised of:
A first section displaying icons 20A currently available to a user 10 when viewing the carousel interface 20;
A second section displaying other icons 20A not currently available for selection by a user 10 on the carousel interface 10;
A means to allow a user to switch between the first and second sections 25A, 25B;
In the first section 25A, a means for a user 10 to select a displayed icon 20A and cause the selected icon 20A to be removed from the first section 25A and simultaneously added to the second section 25B;
In the second section 25B, a means for a user 10 to select a displayed icon 20A and cause the selected icon 20A to be removed from the second section 25B and simultaneously added to the first section 25A; and
A means for a user 10 to save any user-changes made and exit the user dialogue 25.

This embodiment can be further enhanced by further comprising the step of providing the graphical-toolbar application 20 the capability of launching a child toolbar 80 when a predetermined icon 20A is selected by a user 10, the child toolbar 80 comprising a second plurality of icons 80A that are logically linked such that a logical circle of icons is formed, wherein:
Each of the second plurality of icons 80A represents a discrete functional capability associated with a different information-search channel or functionality;
The logical circle is graphically presented as an edge-on view of a second carousel interface 80 within an associated mobile-computing application 30, in order to minimize the amount of user-screen area taken-up by the second carousel interface 80 to maximize the user-screen area available for other mobile-computing-application 30 functionality;
The second carousel interface 80 is adapted such that a subset of the second plurality of icons 80A is displayed at any one time, and each of the displayed icons 80A is user-selectable;
The second carousel interface 80 is adapted to allow a user 10 to scroll the second carousel 80 in either direction to display and/or select additional icons; and
Each of the second plurality of icons 80A, when selected by a user, is adapted to provide added predetermined functionality and information to a user via the balance of an associated mobile-computing application.

This embodiment can be further enhanced wherein the second carousel interface 80 is oriented substantially orthogonally relative to its parent graphical toolbar 20. In a sense, the edge-n view of the child “carousel” 80 can be thought of, instead, as an edge-on view of a “Ferris Wheel”, with the ideal placement to one of the extreme sides of the mobile-computing device 70 display screen in order to maximize the amount of remaining display real estate to be used by the associated mobile-computing application 30. Alternatively, in another variation, the second carousel interface 80 is oriented substantially in parallel relative to its parent graphical toolbar 20, with the ideal placement immediately adjacent to the parent carousel interface 20 in order to maximize the amount of remaining display real estate to be used by the associated mobile-computing application 30.

This embodiment can be enhanced by further comprising the step of providing a multi-input searchbar 40, said searchbar 40 graphically located either above or below, and proximal to, the carousel interface 20, wherein:
The searchbar 40 has a text-input section 40B and launchable program module programmatically coupled to an associated mobile-computing application 30;
The searchbar 40 has an audio-input section 40A and launchable program module programmatically coupled to an associated mobile-computing application 30; and
The searchbar 40 has an image-capture-input section 40C and launchable program module programmatically coupled to an associated mobile-computing application 30.

This enhancement can be varied wherein the carousel interface 20 is adapted to be dynamically populated with said plurality of icons 20A after a user 10 initiates a search via the searchbar 40, the plurality of icons 20A reflecting information channels and/or functionality according to the results of a user-initiated search. In addition, this enhancement can be varied wherein the graphical toolbar 20 is adapted such that a user 10 can select an information-search channel 20A from the carousel interface 20, then initiate a search via the searchbar 40 and associated mobile-computing application 30, wherein the search results are limited to the selected information-search channel 20A. Further, this enhancement can be varied wherein the audio-input section 40A is adapted to receive voice-command inputs via a mobile-computing device's 70 microphone, and/or wherein the image-capture-input section 40C is adapted to receive inputs via a mobile-computing device's 70 camera.

### XI. A Computer-Readable Medium Containing an SDK Defining an API for a Software-Based Graphical Toolbar Used within a Mobile-Computing Application

Refer to FIGS. 1A-10B. This embodiment is generally directed to a computer-readable medium containing a software-development kit (SDK) that defines an application-programming interface (API) for a software-based graphical toolbar 20 used in conjunction with an associated mobile-computing application 30 operating on a mobile-computing device 70 (such as, for example, a mobile phone, smart phone, table computer, and the like). The mobile-computing device 70 typically has a touch screen for user input; however, other devices that use other point-and-select means (e.g., a Blackberry® trackball-and-button scheme) are contemplated as being encompassed within the scope of the embodiments and variations that refer to touching/selecting/pressing features on an application display.

In the present embodiment, the API defines a graphical toolbar 20 comprising a plurality of icons 20A that are logically linked such that a logical circle of icons is formed, wherein:
Each of the plurality of icons 20A represents a discrete functional capability associated with a different information-search channel;
The logical circle is graphically presented as an edge-on view of a carousel interface 20 within an associated mobile-computing application 30, in order to minimize the amount of user-screen area taken-up by the carousel interface 20 to maximize the user-screen area available for other mobile-computing-application 30 functionality;
The carousel interface 20 is adapted such that a subset of the plurality of icons 20A is displayed at any one time, and each of the displayed icons 20A is user-selectable;
The carousel interface 20 is adapted to allow a user 10 to scroll the Carousel 20 in either direction to display and/or select additional icons 20A; and
Each of the plurality of icons 20A, when selected by a user 10, is adapted to provide added predetermined functionality and information to a user 10 via the balance of an associated mobile-computing application 30.

This embodiment can be further enhanced wherein when any of the plurality of icons 20A is selected by a user 10, the carousel interface 20 is programmatically caused to center the selected icon 20B within the viewable part of the carousel interface 20.

This embodiment can be further enhanced wherein the edge-on view of the carousel interface 20 is oriented and rotated relative to a user's 10 view of the user's mobile-computing device 70 display screen by an orientation of either substantially horizontal or substantially vertical.

This embodiment can be further enhanced wherein the information-search channel of each of the plurality of icons 20A represents an Internet-search engine different than at least one of the other icons 20A within the carousel interface 20. In variations, the information-search channel of each of the plurality of icons 20A represents a premium channel reserved for a commercial entity to provide targeted user-search results to a mobile-computing device such that the commercial entity's business interests are promoted while providing information to a user 10. In still more variations, the premium channel results from a given commercial entity paying consideration to the provider of an associated mobile-computing application 30 in order to reserve a channel that is associated with one or more key search terms. In some cases, the commercial entity reserves one or more key search terms and the associated premium channel by renting/leasing or purchasing.

This embodiment can be further enhanced wherein at least one of said plurality of icons 20A represents a functional process related to at least one user-inputted search term, and wherein a user 10 can launch that functional process by selecting the associated icon 20A on the carousel interface 20.

This embodiment can be further enhanced wherein at least one of the plurality of icons 20A represents a functional process that, when selected, launches an augmented-reality application to provide media-rich content, related to the at least one user-inputted search term, back to a mobile-computing device 70.

This embodiment can be further enhanced wherein the graphical-toolbar API further comprises a toolbar-management module 25, the module 25 being launchable by a user 10 by applying a touch or press anywhere on the carousel interface 20 for in excess of a predetermined time, and when launched, displays a user dialogue comprised of:
A first section displaying icons 20A currently available to a user 10 when viewing the carousel interface 20;
A second section displaying other icons 20A not currently available for selection by a user 10 on the carousel interface 10;
A means to allow a user to switch between the first and second sections 25A, 25B;
In the first section 25A, a means for a user 10 to select a displayed icon 20A and cause the selected icon 20A to be removed from the first section 25A and simultaneously added to the second section 25B;
In the second section 25B, a means for a user 10 to select a displayed icon 20A and cause the selected icon 20A to be removed from the second section 25B and simultaneously added to the first section 25A; and
A means for a user 10 to save any user-changes made and exit the user dialogue 25.

This embodiment can be further enhanced wherein the graphical-toolbar API 20 further comprises the capability of launching a child toolbar 80 when a predetermined icon 20A is selected by a user 10, the child toolbar 80 comprising a second plurality of icons 80A that are logically linked such that a logical circle of icons is formed, wherein:
Each of the second plurality of icons 80A represents a discrete functional capability associated with a different information-search channel or functionality;
The logical circle is graphically presented as an edge-on view of a second carousel interface 80 within an associated mobile-computing application 30, in order to minimize the amount of user-screen area taken-up by the second carousel interface 80 to maximize the user-screen area available for other mobile-computing-application 30 functionality;
The second carousel interface 80 is adapted such that a subset of the second plurality of icons 80A is displayed at any one time, and each of the displayed icons 80A is user-selectable;
The second carousel interface 80 is adapted to allow a user 10 to scroll the second carousel 80 in either direction to display and/or select additional icons; and
Each of the second plurality of icons 80A, when selected by a user, is adapted to provide added predetermined functionality and information to a user via the balance of an associated mobile-computing application.

This embodiment can be further enhanced wherein the second carousel interface 80 is oriented substantially orthogonally relative to its parent graphical toolbar 20. In a sense, the edge-n view of the child “carousel” 80 can be thought of, instead, as an edge-on view of a “Ferris Wheel”, with the ideal placement to one of the extreme sides of the mobile-computing device 70 display screen in order to maximize the amount of remaining display real estate to be used by the associated mobile-computing application 30. Alternatively, in another variation, the second carousel interface 80 is oriented substantially in parallel relative to its parent graphical toolbar 20, with the ideal placement immediately adjacent to the parent carousel interface 20 in order to maximize the amount of remaining display real estate to be used by the associated mobile-computing application 30.

This embodiment can be enhanced wherein the graphical-toolbar API 20 further comprises a multi-input searchbar 40, said searchbar 40 graphically located either above or below, and proximal to, the carousel interface 20, wherein:
The searchbar 40 has a text-input section 40B and launchable program module programmatically coupled to an associated mobile-computing application 30;
The searchbar 40 has an audio-input section 40A and launchable program module programmatically coupled to an associated mobile-computing application 30; and
The searchbar 40 has an image-capture-input section 40C and launchable program module programmatically coupled to an associated mobile-computing application 30.

This enhancement can be varied wherein the carousel interface 20 is adapted to be dynamically populated with said plurality of icons 20A after a user 10 initiates a search via the searchbar 40, the plurality of icons 20A reflecting information channels and/or functionality according to the results of a user-initiated search. In addition, this enhancement can be varied wherein the graphical toolbar 20 is adapted such that a user 10 can select an information-search channel 20A from the carousel interface 20, then initiate a search via the searchbar 40 and associated mobile-computing application 30, wherein the search results are limited to the selected information-search channel 20A. Further, this enhancement can be varied wherein the audio-input section 40A is adapted to receive voice-command inputs via a mobile-computing device's 70 microphone, and/or wherein the image-capture-input section 40C is adapted to receive inputs via a mobile-computing device's 70 camera.

### XII. A Method of Making a Computer-Readable Medium Containing an SDK Defining an API for a Software-Based Graphical Toolbar Used within a Mobile-Computing Application

Refer to FIGS. 1A-10B. This embodiment is generally directed to a method of making computer-readable medium containing a software-development kit (SDK) that defines an application-programming interface (API) for a software-based graphical toolbar 20 used in conjunction with an associated mobile-computing application 30 operating on a mobile-computing device 70 (such as, for example, a mobile phone, smart phone, table computer, and the like). The mobile-computing device 70 typically has a touch screen for user input; however, other devices that use other point-and-select means (e.g., a Blackberry® trackball-and-button scheme) are contemplated as being encompassed within the scope of the embodiments and variations that refer to touching/selecting/pressing features on an application display.

In the present embodiment, the method comprises the steps of:
Providing a computer-readable medium; and
Storing computer-readable code on said computer-readable medium, the code comprised of an API that defines a graphical toolbar 20 comprising a plurality of icons 20A that are logically linked such that a logical circle of icons is formed, wherein:
   Each of the plurality of icons 20A represents a discrete functional capability associated with a different information-search channel;
   The logical circle is graphically presented as an edge-on view of a carousel interface 20 within an associated mobile-computing application 30, in order to minimize the amount of user-screen area taken-up by the carousel interface 20 to maximize the user-screen area available for other mobile-computing-application 30 functionality;
   The carousel interface 20 is adapted such that a subset of the plurality of icons 20A is displayed at any one time, and each of the displayed icons 20A is user-selectable;
   The carousel interface 20 is adapted to allow a user 10 to scroll the Carousel 20 in either direction to display and/or select additional icons 20A; and
   Each of the plurality of icons 20A, when selected by a user 10, is adapted to provide added predetermined functionality and information to a user 10 via the balance of an associated mobile-computing application 30.

This embodiment can be further enhanced wherein when any of the plurality of icons 20A is selected by a user 10, the carousel interface 20 is programmatically caused to center the selected icon 20B within the viewable part of the carousel interface 20.

This embodiment can be further enhanced wherein the edge-on view of the carousel interface 20 is oriented and rotated relative to a user's 10 view of the user's mobile-computing device 70 display screen by an orientation of either substantially horizontal or substantially vertical.

This embodiment can be further enhanced wherein the information-search channel of each of the plurality of icons 20A represents an Internet-search engine different than at least one of the other icons 20A within the carousel interface 20. In variations, the information-search channel of each of the plurality of icons 20A represents a premium channel reserved for a commercial entity to provide targeted user-search results to a mobile-computing device such that the commercial entity's business interests are promoted while providing information to a user 10. In still more variations, the premium channel results from a given commercial entity paying consideration to the provider of an associated mobile-computing application 30 in order to reserve a channel that is associated with one or more key search terms. In some cases, the commercial entity reserves one or more key search terms and the associated premium channel by renting/leasing or purchasing.

This embodiment can be further enhanced wherein at least one of said plurality of icons 20A represents a functional process related to at least one user-inputted search term, and wherein a user 10 can launch that functional process by selecting the associated icon 20A on the carousel interface 20.

This embodiment can be further enhanced wherein at least one of the plurality of icons 20A represents a functional process that, when selected, launches an augmented-reality application to provide media-rich content, related to the at least one user-inputted search term, back to a mobile-computing device 70.

This embodiment can be further enhanced wherein the graphical-toolbar API further comprises a toolbar-management module 25, the module 25 being launchable by a user 10 by applying a touch or press anywhere on the carousel interface 20 for in excess of a predetermined time, and when launched, displays a user dialogue comprised of:
A first section displaying icons 20A currently available to a user 10 when viewing the carousel interface 20;
A second section displaying other icons 20A not currently available for selection by a user 10 on the carousel interface 10;
A means to allow a user to switch between the first and second sections 25A, 25B;
In the first section 25A, a means for a user 10 to select a displayed icon 20A and cause the selected icon 20A to be removed from the first section 25A and simultaneously added to the second section 25B;
In the second section 25B, a means for a user 10 to select a displayed icon 20A and cause the selected icon 20A to be removed from the second section 25B and simultaneously added to the first section 25A; and
A means for a user 10 to save any user-changes made and exit the user dialogue 25.

This embodiment can be further enhanced wherein the graphical-toolbar API 20 further comprises the capability of launching a child toolbar 80 when a predetermined icon 20A is selected by a user 10, the child toolbar 80 comprising a second plurality of icons 80A that are logically linked such that a logical circle of icons is formed, wherein:
Each of the second plurality of icons 80A represents a discrete functional capability associated with a different information-search channel or functionality;
The logical circle is graphically presented as an edge-on view of a second carousel interface 80 within an associated mobile-computing application 30, in order to minimize the amount of user-screen area taken-up by the second carousel interface 80 to maximize the user-screen area available for other mobile-computing-application 30 functionality;
The second carousel interface 80 is adapted such that a subset of the second plurality of icons 80A is displayed at any one time, and each of the displayed icons 80A is user-selectable;
The second carousel interface 80 is adapted to allow a user 10 to scroll the second carousel 80 in either direction to display and/or select additional icons; and
Each of the second plurality of icons 80A, when selected by a user, is adapted to provide added predetermined functionality and information to a user via the balance of an associated mobile-computing application.

This embodiment can be further enhanced wherein the second carousel interface 80 is oriented substantially orthogonally relative to its parent graphical toolbar 20. In a sense, the edge-n view of the child “carousel” 80 can be thought of, instead, as an edge-on view of a “Ferris Wheel”, with the ideal placement to one of the extreme sides of the mobile-computing device 70 display screen in order to maximize the amount of remaining display real estate to be used by the associated mobile-computing application 30. Alternatively, in another variation, the second carousel interface 80 is oriented substantially in parallel relative to its parent graphical toolbar 20, with the ideal placement immediately adjacent to the parent carousel interface 20 in order to maximize the amount of remaining display real estate to be used by the associated mobile-computing application 30.

This embodiment can be enhanced wherein the graphical-toolbar API 20 further comprises a multi-input searchbar 40, said searchbar 40 graphically located either above or below, and proximal to, the carousel interface 20, wherein:
The searchbar 40 has a text-input section 40B and launchable program module programmatically coupled to an associated mobile-computing application 30;
The searchbar 40 has an audio-input section 40A and launchable program module programmatically coupled to an associated mobile-computing application 30; and
The searchbar 40 has an image-capture-input section 40C and launchable program module programmatically coupled to an associated mobile-computing application 30.

This enhancement can be varied wherein the carousel interface 20 is adapted to be dynamically populated with said plurality of icons 20A after a user 10 initiates a search via the searchbar 40, the plurality of icons 20A reflecting information channels and/or functionality according to the results of a user-initiated search. In addition, this enhancement can be varied wherein the graphical toolbar 20 is adapted such that a user 10 can select an information-search channel 20A from the carousel interface 20, then initiate a search via the searchbar 40 and associated mobile-computing application 30, wherein the search results are limited to the selected information-search channel 20A. Further, this enhancement can be varied wherein the audio-input section 40A is adapted to receive voice-command inputs via a mobile-computing device's 70 microphone, and/or wherein the image-capture-input section 40C is adapted to receive inputs via a mobile-computing device's 70 camera.

### XIII. A Method of Using a Software-Based Graphical Toolbar Used within a Mobile-Computing Application

Refer to FIGS. 1A-10B. This embodiment is generally directed to a method of using a software-based graphical toolbar 20, according to Section IX, supra, used in conjunction with an associated mobile-computing application 30 operating on a mobile-computing device 70 (such as, for example, a mobile phone, smart phone, table computer, and the like). The mobile-computing device 70 typically has a touch screen for user input; however, other devices that use other point-and-select means (e.g., a Blackberry® trackball-and-button scheme) are contemplated as being encompassed within the scope of the embodiments and variations that refer to touching/selecting/pressing features on an application display.

In the present embodiment, the method comprises the steps of:
By a user 10, on a mobile-computing device 70, launching a mobile-computing application 30 having a graphical toolbar having a carousel interface 20 according to Section IX, supra;
By a user, touching the mobile-computing device's 70 touch screen with a swiping-like motion in order to cause the carousel interface 20 to traverse in either direction until an icon 20A is identified by the user 10 for selection;
By a user 10, selecting the identified icon 20A on the carousel interface 20 by either pressing on, clicking on, or rapidly double-pressing/clicking on the selected icon 20A, depending on the design of the mobile-computing device 70 and the mobile-computing application 30;
By the mobile-computing device 70, causing the selected icon 20A to rotate to the center point 20B of the graphical toolbar 20; and
By the mobile-computing device 70, launching an associated information-search channel and/or functionality programmatically associated with the selected icon 20A.

This embodiment can be further enhanced, by further comprising the steps of:
By the mobile-computing device 70, if the user-selected and pressed icon 20A is configured to launch a child graphical toolbar 80 containing a second plurality of icons 80A to form a second carousel interface 80, displaying the child graphical toolbar with a carousel interface 80;
By a user 10, touching the mobile-computing device's 70 touch screen with a swiping-like motion in order to cause the child carousel interface 80 to traverse in either direction until an icon 80A is identified by the user 10 for selection;
By a user 10, selecting the identified icon 80A on the child carousel interface 80 by either pressing on, clicking on, or rapidly double-pressing/clicking on the selected icon 80A, depending on the design of the mobile-computing device 70 and the mobile-computing application 30; and
By the mobile-computing device 70, causing the selected icon 80A to rotate to the center point 80B of the child graphical toolbar 80; and
By the mobile-computing device 70, launching an associated information-search channel and/or functionality programmatically associated with said selected icon.

This embodiment can be further enhanced, by further comprising the steps of:
By a user 10, continuously touching the carousel interface 20 on the mobile-computing device's 70 touch screen for a predetermined period;
By the mobile-computing device 70, launching an associated user dialogue 25 for adding icons to and/or removing icons from the carousel interface 20;
By a user 10, if an icon 20A is desired to be removed from the carousel interface 20 display, then touching and selecting the icon 20A to be removed from the first section 25A into the second section 25B;
By a user 10, if an icon 20A is desired to be added to the carousel interface 20 display, then touching and selecting the icon 20A to be added from the second section 25B to the first section 25A; and
By a user 10, touching the carousel interface 20 again to close the user dialogue 25 once all desired modifications to the carousel interface 20 are made.

This embodiment can be further enhanced, wherein the mobile-computing device 70 is in communicative coupling 50 with a back-end network 60 adapted to process information-search requests the carousel interface 20 is integrated with a searchbar 40, by further comprising the steps of:
By a user 10, selecting a search-initiation-input method from the searchbar 40, selected from the group comprising text input 40B, audio input 40A, and image input 40C;
By a user 10, initiating an information search on the mobile-computing device 70 according to the selected input method 40A, 40B, 40C;
By the mobile-computing application 30 operating on the mobile-computing device 70, receiving information-search results from the back-end network 60, then populating the graphical toolbar's carousel interface 20 with a set of icons 20A, each of which representing a predetermined channel of information-search results;
By a user 10, touching the mobile-computing device's 70 touch screen with a swiping-like motion in order to cause the carousel interface 20 to traverse in either direction until an icon is identified by the user 10 for selection;
By a user 10, selecting the identified icon 20A on the carousel interface 20 by either pressing on, clicking on, or rapidly double-pressing/clicking on the selected icon 80A, depending on the design of the mobile-computing device 70 and the mobile-computing application 30;
By the mobile-computing device 70, causing the selected icon 20A to rotate to the center point 20B of the graphical toolbar 20; and
By the mobile-computing device 70, launching an associated information-search channel and/or functionality programmatically associated with the selected icon 20A.

This embodiment can be further enhanced; wherein the graphical toolbar 20, 40 is adapted such that a user 10 can select an information-search channel from the carousel interface 20, then initiate a search via the searchbar 40 and associated mobile-computing application 30, wherein the search results are limited to the selected information-search channel; by further comprising the step of:
Before the step of initiating an information search, by a user 10, selecting an information-search channel from the carousel interface 20.

### XIV. Alternative Embodiments and Other Variations

The various embodiments and variations thereof described herein, including the appended claims and accompanying Figures, are merely exemplary and are not meant to limit the scope of the inventive disclosure. It should be appreciated that numerous variations of the invention have been contemplated as would be obvious to one of ordinary skill in the art with the benefit of this disclosure.

For example, the Constent Search Carousel (CSC) described in the various aforementioned embodiments and variations is also contemplated in this disclosure to include applications on non-mobile computing systems, such as a desktop computer running a webbrowser, wherein the CSC is a plugin to the browser, and pointing devices such as a traditional mouse, a touch pad, a track ball, and/or a touch screen may be used to interact with the CSC.

Hence, those ordinarily skilled in the art will have no difficulty devising myriad obvious variations and improvements to the invention, all of which are intended to be encompassed within the scope of the description, claims, and Figures herein.

What is claimed is:

1. A software-based graphical toolbar used in conjunction with an associated computing application operating on a computing device, said computing device having a user display and a user-input pointing means for selecting areas and/or items on said graphical display, the toolbar comprising:
a plurality of icons that are logically linked such that a logical circle of icons is formed, wherein:
each of said plurality of icons represents a discrete functional capability associated with a different information-search channel,
said logical circle is graphically presented as an edge-on view of a carousel interface within an associated computing application, in order to minimize the amount of user-screen area taken-up by said carousel interface to maximize the user-screen area available for other computing-application functionality,
said carousel interface is adapted such that a subset of said plurality of icons is displayed at any one time, and each of said displayed icons is user-selectable,
said carousel interface is adapted to allow a user to scroll said carousel in either direction to display and/or select additional icons, and
each of said plurality of icons, when selected by a user, is adapted to provide added predetermined functionality and information to a user via the balance of an associated computing application.

2. The graphical toolbar of claim 1, wherein when any of said plurality of icons is selected by a user, said carousel interface is programmatically caused to center said selected icon within the viewable part of said carousel interface.

3. The graphical toolbar of claim 1, wherein said edge-on view of said carousel interface is oriented and rotated relative to a user's view of said user's computing device display screen by an orientation selected from the group consisting of substantially horizontal and substantially vertical.

4. The graphical toolbar of claim 1, wherein said information-search channel of each of said plurality of icons represents an Internet-search engine different than at least one of the other said icons within said carousel interface.

5. The graphical toolbar of claim 1, wherein said information-search channel of each of said plurality of icons represents a premium channel reserved for a commercial entity to provide targeted user-search results to a computing device such that said commercial entity's business interests are promoted while providing information to a user.

6. The graphical toolbar of claim 5, wherein said premium channel results from a given commercial entity paying consideration to the provider of an associated computing application in order to reserve a channel that is associated with one or more key search terms.

7. The graphical toolbar of claim 6, wherein said commercial entity reserves said one or more key search terms and said associated premium channel by a means selected from the group consisting of renting and purchasing.

8. The graphical toolbar of claim 1, wherein:
at least one of said plurality of icons represents a functional process related to at least one user-inputted search term, and
a user can launch said functional process by selecting the associated icon on said carousel interface.

9. The graphical toolbar of claim 8, wherein at least one of said plurality of icons represents a functional process that, when selected, launches an augmented-reality application to provide media-rich content, related to said at least one user-inputted search term, back to a computing device.

10. The graphical toolbar of claim 1, wherein said graphical-toolbar application further comprises a toolbar-management module, said module being launchable by a user by selecting a point anywhere on said carousel interface for in excess of a predetermined time, and when launched, displays a user dialogue comprised of:
a first section displaying icons currently available to said user when viewing said carousel interface,
a second section displaying other icons not currently available for selection by said user on said carousel interface,
a means to allow a user to switch between said first and second sections,
in said first section, a means for a user to select a displayed icon and cause said selected icon to be removed from said first section and simultaneously added to said second section,
in said second section, a means for a user to select a displayed icon and cause said selected icon to be removed from said second section and simultaneously added to said first section, and
a means for a user to save any user-changes made and exit said user dialogue.

11. The graphical toolbar of claim 1, wherein said graphical-toolbar application further comprises the capability of launching a child toolbar when a predetermined icon is selected by a user, said child toolbar comprising:
a second plurality of icons that are logically linked such that a logical circle of icons is formed, wherein:
each of said second plurality of icons represents a discrete functional capability associated with a different information-search channel or functionality,
said logical circle is graphically presented as an edge-on view of a second carousel interface within an associated computing application, in order to minimize the amount of user-screen area taken-up by said second carousel interface to maximize the user-screen area available for other computing-application functionality,
said second carousel interface is adapted such that a subset of said second plurality of icons is displayed at any one time, and each of said displayed icons is user-selectable,
said second carousel interface is adapted to allow a user to scroll said second carousel in either direction to display and/or select additional icons, and
each of said second plurality of icons, when selected by a user, is adapted to provide added predetermined functionality and information to a user via the balance of an associated computing application.

12. The graphical toolbar of claim 11, wherein said second carousel interface is oriented substantially orthogonally relative to its parent graphical toolbar.

13. The graphical toolbar of claim 11, wherein said second carousel interface is oriented substantially in parallel relative to its parent graphical toolbar.

14. The graphical toolbar of claim 1, further comprising a multi-input searchbar, said searchbar graphically located either above or below, and proximal to, said carousel interface, wherein:
said searchbar has a text-input section and launchable program module programmatically coupled to an associated computing application;
said searchbar has an audio-input section and launchable program module programmatically coupled to an associated computing application; and
said searchbar has an image-capture-input section and launchable program module programmatically coupled to an associated computing application.

15. The graphical toolbar of claim 14, wherein said carousel interface is adapted to be dynamically populated with said plurality of icons after a user initiates a search via said searchbar, said plurality of icons reflecting information channels and/or functionality according to the results of a user-initiated search.

16. The graphical toolbar of claim 14, adapted such that a user can select an information-search channel from said carousel interface, then initiate a search via said searchbar and associated computing application, wherein the search results are limited to said selected information-search channel.

17. The graphical toolbar of claim 14, wherein said audio-input section is adapted to receive voice-command inputs via a computing device's microphone.

18. The graphical toolbar of claim 14, wherein said image-capture-input section is adapted to receive inputs via a computing device's camera.

19. The graphical toolbar of claim 1, wherein said computing device is a mobile computing device selected from the group consisting of mobile smart phones, tablet computers, and laptop computers.

20. The graphical toolbar of claim 19, wherein said user-input pointing means is selected from the group comprising a touch screen, a touch pad, and a trackball pointer.

21. A method of making a software-based graphical toolbar used in conjunction with an associated computing application operating on a computing device, said computing device having a user display and a user-input pointing means for selecting areas and/or items on said graphical display, the method comprising the step of:
providing a plurality of icons that are logically linked such that a logical circle of icons is formed, wherein:
each of said plurality of icons represents a discrete functional capability associated with a different information-search channel,
said logical circle is graphically presented as an edge-on view of a carousel interface within an associated computing application, in order to minimize the amount of user-screen area taken-up by said carousel interface to maximize the user-screen area available for other computing-application functionality,
said carousel interface is adapted such that a subset of said plurality of icons is displayed at any one time, and each of said displayed icons is user-selectable,
said carousel interface is adapted to allow a user to scroll said carousel in either direction to display and/or select additional icons, and
each of said plurality of icons, when selected by a user, is adapted to provide added predetermined functionality and information to a user via the balance of an associated computing application.

22. The method of claim 21, wherein when any of said plurality of icons is selected by a user, said carousel interface is programmatically caused to center said selected icon within the viewable part of said carousel interface.

23. The method of claim 21, wherein said edge-on view of said carousel interface is oriented and rotated relative to a user's view of said user's computing device display screen by an orientation selected from the group consisting of substantially horizontal and substantially vertical.

24. The method of claim 21, wherein said information-search channel of each of said plurality of icons represents an Internet-search engine different than at least one of the other said icons within said carousel interface.

25. The method of claim 21, wherein said information-search channel of each of said plurality of icons represents a premium channel reserved for a commercial entity to provide targeted user-search results to a computing device such that said commercial entity's business interests are promoted while providing information to a user.

26. The method of claim 25, wherein said premium channel results from a given commercial entity paying consideration to the provider of an associated computing application in order to reserve a channel that is associated with one or more key search terms.

27. The method of claim 26, wherein said commercial entity reserves said one or more key search terms and said associated premium channel by a means selected from the group consisting of renting and purchasing.

28. The method of claim 21, wherein:
at least one of said plurality of icons represents a functional process related to at least one user-inputted search term, and
a user can launch said functional process by selecting the associated icon on said carousel interface.

29. The method of claim 28, wherein at least one of said plurality of icons represents a functional process that, when selected, launches an augmented-reality application to provide media-rich content, related to said at least one user-inputted search term, back to a computing device.

30. The method of claim 21, further comprising the step of providing a toolbar-management module, said module being launchable by a user by selecting a point anywhere on said carousel interface for in excess of a predetermined time, and when launched, displays a user dialogue comprised of:
a first section displaying icons currently available to said user when viewing said carousel interface,
a second section displaying other icons not currently available for selection by said user on said carousel interface,
a means to allow a user to switch between said first and second sections,
in said first section, a means for a user to select a displayed icon and cause said selected icon to be removed from said first section and simultaneously added to said second section,
in said second section, a means for a user to select a displayed icon and cause said selected icon to be removed from said second section and simultaneously added to said first section, and
a means for a user to save any user-changes made and exit said user dialogue.

31. The method of claim 21, further comprising the step of providing said graphical toolbar the capability of launching a child toolbar when a predetermined icon is selected by a user, said child toolbar comprising:
a second plurality of icons that are logically linked such that a logical circle of icons is formed, wherein:
each of said second plurality of icons represents a discrete functional capability associated with a different information-search channel or functionality,
said logical circle is graphically presented as an edge-on view of a second carousel interface within an associated computing application, in order to minimize the amount of user-screen area taken-up by said second carousel interface to maximize the user-screen area available for other computing-application functionality,
said second carousel interface is adapted such that a subset of said second plurality of icons is displayed at any one time, and each of said displayed icons is user-selectable,
said second carousel interface is adapted to allow a user to scroll said second carousel in either direction to display and/or select additional icons, and
each of said second plurality of icons, when selected by a user, is adapted to provide added predetermined functionality and information to a user via the balance of an associated computing application.

32. The method of claim 31, wherein said second carousel interface is oriented substantially orthogonally relative to its parent graphical toolbar.

33. The method of claim 31, wherein said second carousel interface is oriented substantially in parallel relative to its parent graphical toolbar.

34. The method of claim 31, further comprising the step of providing a multi-input searchbar, said searchbar graphically located either above or below, and proximal to, said carousel interface, wherein:
said searchbar has a text-input section and launchable program module programmatically coupled to an associated computing application;
said searchbar has an audio-input section and launchable program module programmatically coupled to an associated computing application; and
said searchbar has an image-capture-input section and launchable program module programmatically coupled to an associated computing application.

35. The method of claim 34, wherein said carousel interface is adapted to be dynamically populated with said plurality of icons after a user initiates a search via said searchbar, said plurality of icons reflecting information channels and/or functionality according to the results of a user-initiated search.

36. The method of claim 34, wherein said graphical toolbar is adapted such that a user can select an information-search channel from said carousel interface, then initiate a search via said searchbar and associated computing application, wherein the search results are limited to said selected information-search channel.

37. The method of claim 34, wherein said audio-input section is adapted to receive voice-command inputs via a computing device's microphone.

38. The method of claim 34, wherein said image-capture-input section is adapted to receive inputs via a computing device's camera.

39. The method of claim 21, wherein said computing device is a mobile computing device selected from the group consisting of mobile smart phones, tablet computers, and laptop computers.

40. The method of claim 39, wherein said user-input pointing means is selected from the group comprising a touch screen, a touch pad, and a trackball pointer.

41. A computer-readable medium containing a software-development kit (SDK) that defines an application-programming interface (API) for a software-based graphical toolbar used in conjunction with an associated computing application operating on a computing device, said computing device having a user display and a user-input pointing means for selecting areas and/or items on said graphical display, wherein said API defines a toolbar comprising the following features:
a plurality of icons that are logically linked such that a logical circle of icons is formed, wherein:
each of said plurality of icons represents a discrete functional capability associated with a different information-search channel,
said logical circle is graphically presented as an edge-on view of a carousel interface within an associated computing application, in order to minimize the amount of user-screen area taken-up by said carousel interface to maximize the user-screen area available for other computing-application functionality,
said carousel interface is adapted such that a subset of said plurality of icons is displayed at any one time, and each of said displayed icons is user-selectable,
said carousel interface is adapted to allow a user to scroll said carousel in either direction to display and/or select additional icons, and
each of said plurality of icons, when selected by a user, is adapted to provide added predetermined functionality and information to a user via the balance of an associated computing application.

42. The computer-readable medium of claim 37, wherein when any of said plurality of icons is selected by a user, said carousel interface is programmatically caused to center said selected icon within the viewable part of said carousel interface.

43. The computer-readable medium of claim 37, wherein said edge-on view of said carousel interface is oriented and rotated relative to a user's view of said user's computing device display screen by an orientation selected from the group consisting of substantially horizontal and substantially vertical.

44. The computer-readable medium of claim 37, wherein said information-search channel of each of said plurality of icons represents an Internet-search engine different than at least one of the other said icons within said carousel interface.

45. The computer-readable medium of claim 37, wherein said information-search channel of each of said plurality of icons represents a premium channel reserved for a commercial entity to provide targeted user-search results to a computing device such that said commercial entity's business interests are promoted while providing information to a user.

46. The computer-readable medium of claim 41, wherein said premium channel results from a given commercial entity paying consideration to the provider of an associated computing application in order to reserve a channel that is associated with one or more key search terms.

47. The computer-readable medium of claim 42, wherein said commercial entity reserves said one or more key search terms and said associated premium channel by a means selected from the group consisting of renting and purchasing.

48. The computer-readable medium of claim 37, wherein:
at least one of said plurality of icons represents a functional process related to at least one user-inputted search term, and
a user can launch said functional process by selecting the associated icon on said carousel interface.

49. The computer-readable medium of claim 44, wherein at least one of said plurality of icons represents a functional process that, when selected, launches an augmented-reality application to provide media-rich content, related to said at least one user-inputted search term, back to a computing device.

50. The computer-readable medium of claim 37, wherein said graphical-toolbar API further comprises a toolbar-management module, said module being launchable by a user by selecting a point anywhere on said carousel interface for in excess of a predetermined time, and when launched, displays a user dialogue comprised of:
a first section displaying icons currently available to said user when viewing said carousel interface,
a second section displaying other icons not currently available for selection by said user on said carousel interface,
a means to allow a user to switch between said first and second sections,
in said first section, a means for a user to select a displayed icon and cause said selected icon to be removed from said first section and simultaneously added to said second section,
in said second section, a means for a user to select a displayed icon and cause said selected icon to be removed from said second section and simultaneously added to said first section, and
a means for a user to save any user-changes made and exit said user dialogue.

51. The computer-readable medium of claim 37, wherein said graphical-toolbar API further comprises the capability of launching a child toolbar when a predetermined icon is selected by a user, said child toolbar comprising:
a second plurality of icons that are logically linked such that a logical circle of icons is formed, wherein:
each of said second plurality of icons represents a discrete functional capability associated with a different information-search channel or functionality,
said logical circle is graphically presented as an edge-on view of a second carousel interface within an associated computing application, in order to minimize the amount of user-screen area taken-up by said second carousel interface to maximize the user-screen area available for other computing-application functionality,
said second carousel interface is adapted such that a subset of said second plurality of icons is displayed at any one time, and each of said displayed icons is user-selectable,
said second carousel interface is adapted to allow a user to scroll said second carousel in either direction to display and/or select additional icons, and
each of said second plurality of icons, when selected by a user, is adapted to provide added predetermined functionality and information to a user via the balance of an associated computing application.

52. The computer-readable medium of claim 47, wherein said second carousel interface is oriented substantially orthogonally relative to its parent graphical toolbar.

53. The computer-readable medium of claim 47, wherein said second carousel interface is oriented substantially in parallel relative to its parent graphical toolbar.

54. The computer-readable medium of claim 37, wherein said graphical toolbar API further comprises a multi-input searchbar, said searchbar graphically located either above or below, and proximal to, said carousel interface, wherein:
said searchbar has a text-input section and launchable program module programmatically coupled to an associated computing application;
said searchbar has an audio-input section and launchable program module programmatically coupled to an associated computing application; and
said searchbar has an image-capture-input section and launchable program module programmatically coupled to an associated computing application.

55. The computer-readable medium of claim 50, wherein said carousel interface is adapted to be dynamically populated with said plurality of icons after a user initiates a search via said searchbar, said plurality of icons reflecting information channels and/or functionality according to the results of a user-initiated search.

56. The computer-readable medium of claim 50, wherein said graphical toolbar is adapted such that a user can select an information-search channel from said carousel interface, then initiate a search via said searchbar and associated computing application, wherein the search results are limited to said selected information-search channel.

57. The computer-readable medium of claim 50, wherein said audio-input section is adapted to receive voice-command inputs via a computing device's microphone.

58. The computer-readable medium of claim 50, wherein said image-capture-input section is adapted to receive inputs via a computing device's camera.

59. The computer-readable medium of claim 41, wherein said computing device is a mobile computing device selected from the group consisting of mobile smart phones, tablet computers, and laptop computers.

60. The computer-readable medium of claim 59, wherein said user-input pointing means is selected from the group comprising a touch screen, a touch pad, and a trackball pointer.

61. A method of making a computer-readable medium containing a software-development kit (SDK) that defines an application-programming interface (API) for a software-based graphical toolbar used in conjunction with an associated computing application operating on a computing device, said computing device having a user display and a user-input pointing means for selecting areas and/or items on said graphical display, the method comprising the steps of:
providing a computer-readable medium; and
storing computer-readable code on said computer-readable medium, said code comprised of an API that defines a toolbar comprising the following features:
a plurality of icons that are logically linked such that a logical circle of icons is formed, wherein:
each of said plurality of icons represents a discrete functional capability associated with a different information-search channel,
said logical circle is graphically presented as an edge-on view of a carousel interface within an associated computing application, in order to minimize the amount of user-screen area taken-up by said carousel interface to maximize the user-screen area available for other computing-application functionality,
said carousel interface is adapted such that a subset of said plurality of icons is displayed at any one time, and each of said displayed icons is user-selectable,
said carousel interface is adapted to allow a user to scroll said carousel in either direction to display and/or select additional icons, and
each of said plurality of icons, when selected by a user, is adapted to provide added predetermined functionality and information to a user via the balance of an associated computing application.

62. The method of claim 55, wherein when any of said plurality of icons is selected by a user, said carousel interface is programmatically caused to center said selected icon within the viewable part of said carousel interface.

63. The method of claim 55, wherein said edge-on view of said carousel interface is oriented and rotated relative to a user's view of said user's computing device display screen by an orientation selected from the group consisting of substantially horizontal and substantially vertical.

64. The method of claim 55, wherein said information-search channel of each of said plurality of icons represents an Internet-search engine different than at least one of the other said icons within said carousel interface.

65. The method of claim 55, wherein said information-search channel of each of said plurality of icons represents a premium channel reserved for a commercial entity to provide targeted user-search results to an associated computing device such that said commercial entity's business interests are promoted while providing information to a user.

66. The method of claim 59, wherein said premium channel results from a given commercial entity paying consideration to the provider of an associated computing application in order to reserve a channel that is associated with one or more key search terms.

67. The method of claim 60, wherein said commercial entity reserves said one or more key search terms and said associated premium channel by a means selected from the group consisting of renting and purchasing.

68. The method of claim 55, wherein:
at least one of said plurality of icons represents a functional process related to at least one user-inputted search term, and
a user can launch said functional process by selecting the associated icon on said carousel interface.

69. The method of claim 62, wherein at least one of said plurality of icons represents a functional process that, when selected, launches an augmented-reality application to provide media-rich content, related to said at least one user-inputted search term back, to a computing device.

70. The method of claim 55, wherein said graphical-toolbar API further comprises a toolbar-management module, said module being launchable by a user by selecting a point anywhere on said carousel interface for in excess of a predetermined time, and when launched, displays a user dialogue comprised of:
a first section displaying icons currently available to said user when viewing said carousel interface,
a second section displaying other icons not currently available for selection by said user on said carousel interface,
a means to allow a user to switch between said first and second sections,
in said first section, a means for a user to select a displayed icon and cause said selected icon to be removed from said first section and simultaneously added to said second section,
in said second section, a means for a user to select a displayed icon and cause said selected icon to be removed from said second section and simultaneously added to said first section, and
a means for a user to save any user-changes made and exit said user dialogue.

71. The method of claim 55, wherein said graphical-toolbar API further comprises the capability of launching a child toolbar when a predetermined icon is selected by a user, said child toolbar comprising:
a second plurality of icons that are logically linked such that a logical circle of icons is formed, wherein:
each of said second plurality of icons represents a discrete functional capability associated with a different information-search channel or functionality,
said logical circle is graphically presented as an edge-on view of a second carousel interface within an associated computing application, in order to minimize the amount of user-screen area taken-up by said second carousel interface to maximize the user-screen area available for other computing-application functionality,
said second carousel interface is adapted such that a subset of said second plurality of icons is displayed at any one time, and each of said displayed icons is user-selectable,
said second carousel interface is adapted to allow a user to scroll said second carousel in either direction to display and/or select additional icons, and
each of said second plurality of icons, when selected by a user, is adapted to provide added predetermined functionality and information to a user via the balance of an associated computing application.

72. The method of claim 65, wherein said second carousel interface is oriented substantially orthogonally relative to its parent graphical toolbar.

73. The method of claim 65, wherein said second carousel interface is oriented substantially in parallel relative to its parent graphical toolbar.

74. The method of claim 55, wherein said graphical toolbar API further comprises a multi-input searchbar, said searchbar graphically located either above or below, and proximal to, said carousel interface, wherein:
said searchbar has a text-input section and launchable program module programmatically coupled to an associated computing application;
said searchbar has an audio-input section and launchable program module programmatically coupled to an associated computing application; and
said searchbar has an image-capture-input section and launchable program module programmatically coupled to an associated computing application.

75. The method of claim 68, wherein said carousel interface is adapted to be dynamically populated with said plurality of icons after a user initiates a search via said searchbar, said plurality of icons reflecting information channels and/or functionality according to the results of a user-initiated search.

76. The method of claim 68, wherein said graphical toolbar is adapted such that a user can select an information-search channel from said carousel interface, then initiate a search via said searchbar and associated computing application, wherein the search results are limited to said selected information-search channel.

77. The method of claim 68, wherein said audio-input section is adapted to receive voice-command inputs via a computing device's microphone.

78. The method of claim 68, wherein said image-capture-input section is adapted to receive inputs via a computing device's camera.

79. The method of claim 61, wherein said computing device is a mobile computing device selected from the group consisting of mobile smart phones, tablet computers, and laptop computers.

80. The method of claim 79, wherein said user-input pointing means is selected from the group comprising a touch screen, a touch pad, and a trackball pointer.

81. A method of using a software-based graphical toolbar according to claim 1 operating in conjunction with an associated mobile-computing application, and operating on a mobile-computing device having a touch screen, the method comprising the steps of:
by a user, on a mobile-computing device, launching a mobile-computing application having a graphical toolbar having a carousel interface according to claim 1;
by a user, touching said mobile-computing device's touch screen with a swiping-like motion in order to cause said carousel interface to traverse in either direction until an icon is identified by said user for selection;
by a user, selecting said identified icon on said carousel interface by a method selected from the group consisting of pressing on selected icon and rapidly double-pressing on said selected icon; and
by said mobile-computing device, causing said selected icon to rotate to the center point of said graphical toolbar; and
by said mobile-computing device, launching an associated information-search channel and/or functionality programmatically associated with said selected icon.

82. The method of claim 81, wherein said software-based graphical toolbar further comprises the limitations of claim 11, the method further comprising the steps of:
by said mobile-computing device, if said user-selected and pressed icon is configured to launch a child graphical toolbar containing a second plurality of icons to form a second carousel interface, displaying said child graphical toolbar with a carousel interface;
by a user, touching said mobile-computing device's touch screen with a swiping-like motion in order to cause said child carousel interface to traverse in either direction until an icon is identified by said user for selection;
by a user, selecting said identified icon on said child carousel interface by a method selected from the group consisting of pressing on selected icon and rapidly double-pressing on said selected icon; and
by said mobile-computing device, causing said selected icon to rotate to the center point of said child graphical toolbar; and
by said mobile-computing device, launching an associated information-search channel and/or functionality programmatically associated with said selected icon.

83. A method of using a software-based graphical toolbar according to claim 10 operating in conjunction with an associated mobile-computing application, and operating on a mobile-computing device having a touch screen, the method comprising the steps of:
by a user, on a mobile-computing device, launching a computing application having a graphical toolbar having a carousel interface according to claim 10;
by a user, continuously touching said carousel interface on said mobile-computing device's touch screen for a predetermined period;
by said mobile-computing device, launching an associated user dialogue for adding icons to and/or removing icons from said carousel interface;
by a user, if an icon is desired to be removed from said carousel interface display, then touching and selecting said icon to be removed from said first section into said second section;
by a user, if an icon is desired to be added to said carousel interface display, then touching and selecting said icon to be added from said second section to said first section; and
by a user, touching said carousel interface again to close said user dialogue once all desired modifications to said carousel interface are made.

84. A method of using a software-based graphical toolbar according to claim 14 operating in conjunction with an associated mobile-computing application, and operating on a mobile-computing device, the method comprising the steps of:
by a user, on a mobile-computing device in communicative coupling with a back-end network adapted to process information-search requests, launching a mobile-computing application having a graphical toolbar having a carousel interface and an integrated searchbar according to claim 14;
by a user, selecting a search-initiation-input method from said searchbar, selected from the group comprising text input, audio input, and image input;
by a user, initiating an information search on said computing device according to said selected input method;
by said mobile-computing application operating on said mobile-computing device, receiving information-search results from said back-end network, then populating said graphical toolbar's carousel interface with a set of icons, each of which representing a predetermined channel of information-search results;
by a user, touching said mobile-computing device's touch screen with a swiping-like motion in order to cause said carousel interface to traverse in either direction until an icon is identified by said user for selection;
by a user, selecting said identified icon on said carousel interface by a method selected from the group consisting of pressing on selected icon and rapidly double-pressing on said selected icon;
by said mobile-computing device, causing said selected icon to rotate to the center point of said graphical toolbar; and
by said mobile-computing device, launching an associated information-search channel and/or functionality programmatically associated with said selected icon.

85. The method of claim 84, wherein said graphical toolbar further comprises the limitations of claim 16, the method further comprising the step of:
before the step of initiating an information search, by a user, selecting an information-search channel from said carousel interface.
